(19) United States
(12) Patent Application Publication
(10) Pub. No.: US 2022/0014354 A1
(43) Pub. Date: Jan. 13, 2022

(54) SYSTEMS, METHODS AND DEVICES FOR PROVISION OF A SECRET

(71) Applicant: ZIVA CONNECT PTY LTD, Balmain, New South Wales (AU)

(72) Inventors: Dominique VALLADOLID, Balmain (AU); Jose Luis Lobo VASQUEZ, Balmain (AU); Yuval HERTZOG, Balmain (AU); Matthew SPENCER, Balmain (AU); Michael LOEWY, Balmain (AU); Issac ELNEKAVE, Balmain (AU); Willy SUSILO, Balmain (AU)

(21) Appl. No.: 17/436,956

(22) PCT Filed: Mar. 6, 2020
(86) PCT No.: PCT/AU2020/050217

§ 371 Date: Sep. 7, 2021

(30) Foreign Application Priority Data
Mar. 7, 2019 (AU) 2019900762
Mar. 7, 2019 (AU) 2019900764

(51) Int. Cl. H04L 9/08; H04L 9/32

(52) U.S. Cl. CPC H04L 9/085; H04L 2209/38; H04L 9/3231; H04L 9/0819

(57) ABSTRACT

A method (200) performed by a plurality of servers (108) to each provide a share (110) of a secret to an owner (102) of the secret is disclosed. The share of the secret (110) is generated using a cryptographic share generation method. The plurality of servers (108) each store a different share and an associated unique identifier indicative of the owner, the unique identifier having a corresponding verifier. Each of the plurality of servers receives a request (202) from a user (102) to provide the share stored by the server. The server identifies (204) the share stored by the server using a request identifier and further compares a request verifier to the verifier corresponding to the unique identifier associated with the stored share. If the request verifier suitably compares, the server authenticates (206) the user as the owner by providing the share (208) to the user.

### CROSS-REFERENCE TO RELATED APPLICATIONS

The present application claims priority from Australian Provisional Patent Application No 2019900762 filed on 7 Mar. 2019, Australian Provisional Patent Application No 2019900764 filed on 7 Mar. 2019, the contents of which are incorporated herein by reference in their entirety.

### TECHNICAL FIELD

This disclosure relates to systems, methods and devices for storing and providing secrets and in particular, but not limited to, systems, methods and devices for storing, providing and automatically using a private cryptographic key.

### BACKGROUND

Cryptography relates to protocols for securely transmitting data between a sender and a recipient. The protocols do not prevent third parties from intercepting the data, but rather prevent the third party from being able to read or interpret data that is intercepted. The protocols typically involve an encryption step, performed by the sender, and a decryption step, performed by the recipient. The encryption step involves altering the data in a specific manner such that the encrypted data appears unintelligible if intercepted. The decryption step involves altering the encrypted data to return the original data, thereby revealing the data to the recipient. Decryption is essentially an inverse process of encryption.

In modern, digital cryptography, numbers, known as keys, are used to encrypt and decrypt the data. In the case of symmetric key cryptography, the keys are symmetric, meaning that the same key is used to encrypt and decrypt the message. The security of the system therefore relies on the message sender being able to securely provide the key to the receiver. In the case of asymmetric key cryptography, also known as public key cryptography, the encryption key and decryption key are different.

In asymmetric cryptography, a pair of mathematically related keys, known as a public/private key pair is used. The public key can be freely distributed while the related private key is kept secret. A sender is able to encrypt data using a public key associated with a receiver which can then decrypt the data using the related private key. Public keys are frequently used as an identifier for a user.

A similar process can be used to verify the authenticity of a digital object. This process involves a user encrypting the digital object using a private key of the user. The encrypted object, termed a digital signature of the object, can then be verified by any other party by decrypting it using the public key associated with the user's private key. Assuming the user has maintained the secrecy of the private key, the verified digital signature authenticates the source of the object as well as the integrity. The authenticity of the source is guaranteed by the fact that it is only possible to create the signature using the private key associated with the user's public key. Therefore, verification guarantees that the entity creating the signature had access to the private key (which is assumed to have been kept secret).

The integrity of the digital object is guaranteed by the fact that alteration of the object after creation of the digital signature would not allow for verification.

### SUMMARY

Aspects, including embodiments, of the present subject matter described herein may be beneficial alone or in combination, with one or more other aspects or embodiments. Each individual aspect may be used or combined with any of the other aspects. This is intended to provide support for all such combinations of aspects and is not limited to combinations of aspects explicitly provided below.

The present disclosure provides a method performed by a plurality of servers to each provide a share of a secret to an owner of the secret, the share generated from the secret by a deterministic or probabilistic cryptographic share generation method, wherein the plurality of servers each store a different share of the secret and an associated a unique identifier indicative of the owner, the unique identifier having a corresponding verifier, the method comprising each of the plurality of servers:

receiving a request from a user to provide the share stored by the server, wherein the request comprises a request identifier and a request verifier;

the server identifying the share stored by the server by comparing the request identifier with the unique identifier associated with the stored share;

the server comparing the request verifier to the verifier corresponding to the unique identifier associated with the stored share; and

if the request verifier suitably compares to the verifier corresponding to the unique identifier, authenticating the user as the owner by providing the share to the user.

It is an advantage of this method that the secret can be stored remotely and returned to the owner upon request without having to store the whole secret in a single location that must be trusted.

The request verifier may comprise a randomised password and comparing the request verifier to the verifier corresponding to the unique identifier may comprise generating a random challenge to the user.

The corresponding verifier may be specific to the server that stores the share. It is an advantage of this method that none of the servers have access to either the secret or the verifier.

The corresponding verifier may be generated by a deterministic process based on a public key of the server. It is an advantage of this method that no record of the server-specific verifiers is required as the deterministic process can generate them on demand.

The corresponding verifier may be generated by a deterministic process based on an internet protocol (IP) address of the server.

The corresponding verifier may comprise a share of a public key, wherein the share of the public key is generated from a public key using a deterministic or probabilistic cryptographic secret sharing method.

The public key may be generated from a second alphanumeric sequence provided by the user. It is an advantage of this method that the user is only required to remember an alphanumeric sequence such as a password.

The corresponding verifier may be based on biometric information of the user.

The share stored by the server may be encrypted using a server public key of the server.

The unique identifier may be generated by a deterministic cryptographic hash function of a first alphanumeric sequence provided by the user. It is an advantage of this method that no server has access to the user's username.

Each share may be recorded in one or more trustless repositories.

The trustless repository may be a distributed ledger.

The distributed ledger may be a blockchain.

The method may further comprise randomly selecting one or more of the plurality of servers from a pool of potential servers.

A number of servers in the plurality of servers may be greater than a threshold number. It is an advantage of this method that there is redundancy in the number of servers and hence the system is more robust to server outages.

The method may further comprise the steps of:

receiving a subsequent request comprising the same request identifier; and

after a delay period, repeating the comparing steps.

The method may be repeated with an increasing delay for each repeat.

In another aspect, the present disclosure provides a server for providing a share of a secret to an owner of the secret, the share generated from the secret by a deterministic or probabilistic cryptographic share generation method, the server comprising:

a processing unit having at least one processor configured to:

receive a request from a user to provide the share, wherein the request comprises a request identifier and a request verifier;

access one or more repositories configured to store the share of the secret and an associated a unique identifier indicative of the owner of the secret, the unique identifier having a corresponding verifier;

identify the share stored by the server by comparing the request identifier with the unique identifier associated with the share;

compare the request verifier to the verifier corresponding to the unique identifier associated with the share; and

if the request verifier suitably compares to the verifier corresponding to the unique identifier, authenticate the user as the owner by providing the share to the user.

In a further aspect, the present disclosure provides a system for providing a plurality of shares of a secret to an owner of the secret, the shares generated from the secret by a deterministic or probabilistic cryptographic share generation method, the system comprising:

one or more repositories configured to store the shares of the secret in association with a unique identifier indicative of the owner, the unique identifier having one or more corresponding verifiers; and

a plurality of servers each configured to:
receive a request from a user to provide the share, wherein the request comprises a request identifier and a request verifier;
identify the share stored in the one or more repositories by comparing the request identifier with the unique identifier associated with the stored share;
compare the request verifier to the verifier corresponding to the unique identifier associated with the stored share; and
if the request verifier suitably compares to the verifier corresponding to the unique identifier, authenticate the user as the owner by providing the share to the user.

In another aspect, the present disclosure provides software having instructions that when executed cause a processor to perform:

receive a request from a user to provide a share of a secret stored by the server, wherein the request comprises a request identifier and a request verifier;

access a repository storing the share of the secret, the share of the secret generated from a secret by a deterministic or probabilistic cryptographic share generation method,

identify the share stored in the repository by comparing the request identifier with a unique identifier associated with the stored share;

compare the request verifier to a verifier corresponding to the unique identifier associated with the stored share; and

if the request verifier suitably compares to the verifier corresponding to the unique identifier, provide the share to the user;

the software may be non-transitory computer readable medium configured to store the instructions.

In a further aspect, the present disclosure provides a method performed by an owner of a secret to retrieve the secret, the method comprising:

sending a request to each of a plurality of servers, wherein each of the plurality of servers is configured to store a different share of the secret, wherein each different share of the secret was generated from the secret by a deterministic or probabilistic cryptographic share generation method, the request comprising a request identifier and a request verifier;

receiving a threshold number of different shares from a threshold number of servers of the plurality of servers; and

reconstructing the secret from the threshold number of different shares.

In a further aspect, the present disclosure provides a device for retrieving a secret, the device comprising a processor configured to:

send a request to each of a plurality of servers, wherein each of the plurality of servers is configured to store a different share of the secret, wherein each different share of the secret was generated from the secret by a deterministic or probabilistic cryptographic share generation method, the request comprising a request identifier and a request verifier;

receive a threshold number of different shares from a threshold number of servers of the plurality of servers; and

reconstruct the secret from the threshold number of different shares.

In another aspect, the present disclosure provides software having instructions that when executed cause a processor to perform:

send a request to each of a plurality of servers, wherein each of the plurality of servers is configured to store a different share of the secret, wherein each different share of the secret was generated from the secret by a deterministic or probabilistic cryptographic share generation method, the request comprising a request identifier and a request verifier;

receive a threshold number of different shares from a threshold number of servers of the plurality of servers; and

reconstruct the secret from the threshold number of different shares;

the software may be non-transitory computer readable medium configured to store the instructions.

In a further aspect, the present disclosure a method performed by a plurality of servers to each provide a share of a secret to an owner of the secret, the share of the secret generated from the secret by a deterministic or probabilistic cryptographic share generation method, wherein the plurality of servers each store a different share of the secret in association with a unique identifier indicative of the owner, the unique identifier having a corresponding verifier, the method comprising each of the plurality of servers:

receiving a request from a user to provide the share stored by the server, wherein the request comprises a request identifier and a request verifier;

the server identifying the share stored by the server by comparing the request identifier with the unique identifier associated with the stored share;

the server combining the request verifier with the stored share and the verifier corresponding to the unique identifier associated with the stored share to define a combined share; and

providing the combined share to the user.

In another aspect, the present disclosure provides a method performed by a plurality of servers to each provide to an end user a partially actioned digital object, wherein the plurality of servers each store a different share of a cryptographic key, the method comprising each of the plurality of servers:

receiving a request to action the digital object using the cryptographic key;

determining whether one or more predefined conditions are satisfied;

where the one or more predefined conditions are satisfied, partially actioning the digital object using the share of the cryptographic key to generate a partially actioned digital object; and

providing to an end user the partially actioned digital object.

It is an advantage of this method that application of a cryptographic key can be autonomous, not requiring explicit, manual input from the owner of the key for all instances. It is a further advantage that the cryptographic key can be maintained by the plurality of servers for use by the end user without exposing the whole key to any entity, including any individual server. An additional advantage is that the user does not need to store the whole, or any part of, the cryptographic key to use it. this makes is simple for the user and is also secure as the whole key is not exposed to any of the servers.

Each server may store the share of the cryptographic key in a distributed ledger.

The predefined conditions may be stored in a distributed ledger.

The predefined conditions may include terms of a contract.

The method may further comprise the end user combining the partially actioned digital objects.

Partially actioning the digital object may comprise partially digitally signing the digital object with the share of the cryptographic key.

Before providing to the end user the partially actioned digital object, each server may partially encrypt the partially actioned digital object using a public key of the end user.

Partially actioning the digital object may comprise partially decrypting the digital object.

Partially actioning the digital object may comprise partially certifying the digital object through a generation of a certificate.

The method may comprise selecting the plurality of servers from a pool of potential servers. It is an advantage of this method that it is more difficult for a malicious agent to identify the serves making up the trustee.

The method may comprise randomly selecting one or more of the plurality of servers.

The number of servers may be greater than a threshold number. It is an advantage of this embodiment that there is redundancy in the number of servers and hence the system is more robust to server outages.

In a further aspect, the present disclosure provides a system for automatically actioning a digital object with a cryptographic key, the system including:

one or more repositories for storing one or more predefined conditions and shares of the cryptographic key; and

a plurality of servers each configured to:
receive a request for the digital object to be actioned using the cryptographic key;
access a share of the cryptographic key;
determine whether one or more predefined conditions are satisfied;
where the one or more predefined conditions are satisfied, partially action the digital object using the share of the cryptographic key to generate a partially actioned digital object; and
provide to an end user the partially actioned digital object.

In another aspect, the present disclosure provides a server for partially actioning a digital object with a share of a cryptographic key, the server comprising a processor configured to:

receive a request for the digital object to be actioned using the cryptographic key;

access a share of the cryptographic key;

determine whether one or more predefined conditions are satisfied;

where the one or more predefined conditions are satisfied, partially action the digital object using the share of the cryptographic key to generate a partially actioned digital object; and

provide to an end user the partially actioned digital object.

In a further aspect, the present disclosure provides a non-transitory computer readable medium configured to store instructions that when executed cause a processor to perform any one of the above methods.

In another aspect, the present disclosure provides a method performed by an end user to action a digital object with a cryptographic key of an owner, the method including:

sending a request to each of a plurality of servers, wherein each of the plurality of servers is configured to store a different share of the cryptographic key and to partially action the digital object using the stored share of the cryptographic key and provide a partially actioned digital object to the end user, the request comprising proof of predefined conditions being satisfied;

receiving a threshold number of different partially actioned digital objects from a threshold number of servers of the plurality of servers;

reconstructing an actioned digital object from the threshold number of partially actioned digital objects.

In a further aspect, the present disclosure provides a device for obtaining an actioned digital object, the device comprising a processor configured to:

send a request to each of a plurality of servers, wherein each of the plurality of servers is configured to store a different share of the cryptographic key and to partially action the digital object using the stored share of the cryptographic key and provide a partially actioned digital object to the end user, the request comprising proof of predefined conditions being satisfied;

receive a threshold number of different partially actioned digital objects from a threshold number of servers of the plurality of servers;

reconstruct the actioned digital object from the threshold number of partially actioned digital objects.

In another aspect, the present disclosure provides a non-transitory computer readable medium configured to store instructions that when executed cause a processor to perform the method performed by the end user described above.

At least a portion of the servers may be selected by an owner of the cryptographic key.

A first portion of the delegated servers may be owned by a first entity and a second portion of the delegated servers may be owned by a second entity.

A first portion of the delegated servers may be located in a first geographical location and a second portion of the delegated servers may be located in a second geographical location.

The shares may be formed using at least one of: Shamir's secret sharing technique, Feldman's secret sharing technique, Pederson's secret sharing technique or Stadler's secret sharing technique.

The encryption system may be the ElGamal encryption system.

The encryption system may include at least one of lattice-based, N-th degree Truncated polynomial Ring Units (NTRU) or Learning With Errors (LWE).

### BRIEF DESCRIPTION OF DRAWINGS

A preferred embodiment of the invention will now be described, by way of example only, with reference to the accompanying drawings in which:

FIG. 1 is a schematic representation of a system according to one embodiment;

FIG. 2 is a flow diagram of a method performed by a server;

FIG. 3 is a flow diagram of a method performed by a server;

FIG. 4 is a flow diagram of a method performed by a server;

FIG. 5 is a flow diagram of an exemplary method performed by a new user of the system of FIG. 1;

FIG. 6 is a flow diagram of an exemplary method for depositing a cryptographic key in the system of FIG. 1;

FIG. 7 is a flow diagram of an exemplary method for depositing a cryptographic key in the system of FIG. 1;

FIG. 8 is a flow diagram of an exemplary method performed by a user of the system of FIG. 1;

FIG. 9A is a flow diagram of an exemplary method for generating a verifier shares;

FIG. 9B is a flow diagram of an exemplary method for generating verifier shares;

FIG. 9C is a flow diagram of an exemplary method for generating a verifier;

FIG. 9D illustrates a method for verifying a password;

FIG. 10 is a flow diagram of an exemplary method for retrieving a secret;

FIG. 11 is a flow diagram of a method performed by a server;

FIG. 12 is a schematic representation of a system according to an embodiment;

FIG. 13 is a flow diagram of a method performed by a server;

FIG. 14 is a flow diagram of an exemplary method for depositing a cryptographic key in the system of FIG. 12;

FIG. 15 is a flow diagram of an exemplary method for depositing a cryptographic key in the system of FIG. 12;

FIG. 16 is a flow diagram of an exemplary method performed by the system of FIG. 12; and

FIG. 17 is an illustration of an application of the system of FIG. 12.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### DESCRIPTION OF EMBODIMENTS

As the digital economy grows, so does the number of applications making use of client-side encryption wherein a user is required to perform some cryptographic process on a digital object. A digital object may be a byte array, a message, a string, a binary file etc. The process may be a simple encryption of digital communications, authentication of a signed document or verification of identity.

For example, the proliferation of Distributed Ledger Technologies (DLT) is raising awareness of the benefits of trustless techniques to drive financial, commercial and social interchange of values on a global scale. Blockchain, as the most commonly known DLT, utilizes public-key cryptography to guarantee the sovereignty of an individual over their tokenized assets. Anything and everything a blockchain user is engaging with, is either signed by that user's key or encrypted and decrypted with that user's key—which guarantees that only that user can transact with its assets. This characteristic of blockchain is also one of its significant barriers from achieving mass adoption: it's simply too complicated (to be done in a totally trustless fashion). Indeed, the problems outlined below are common to all key-based transaction systems.

As mentioned above, it is an assumption in cryptographic protocols that a user maintains the secrecy of a cryptographic key. This is true regardless of the specific application or whether a symmetric or asymmetric cryptographic protocol is being used.

For typical applications, a 256-bit key provides an adequate level of security. However, storage of such a key has been identified by the inventors as a significant issue because successfully memorising the key is highly improbable and would be extremely onerous on the user. Furthermore, any user friendly storage diminishes the security. For example, storage of the key on a server requires trusting all administrators of the server and relying on the robustness of the server security.

A further problem has been identified for situation in which the key, or its mnemonic phrase, are lost or forgotten. The problem arises as it is assumed that user is the only one with access to the key. Restoring the key to the user would require a third party to be in possession of the key which exposes the key to similar risks as those created by storing the key on a server.

Additionally, active participation of the user is typically required in key-based transactions. This inability to securely perform tasks with the key, on behalf of the user, prevents almost all aspects of automation in regards to the user's encrypted assets.

### Overview: Retrieval of a Secret

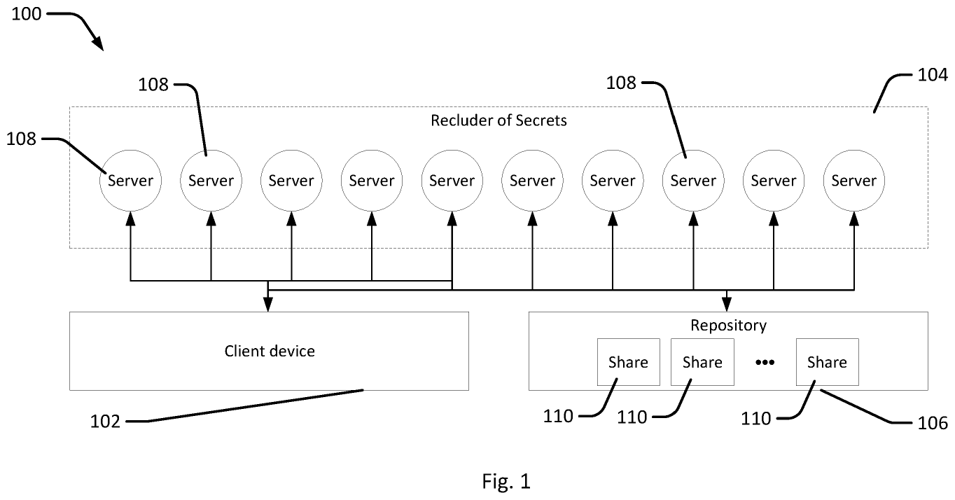

A system 100 for allowing a user, operating client device 102, to store and retrieve a secret is shown in FIG. 1. Throughout the description the user will be represented by client device 102 and the terms will be used interchangeably unless explicitly stated otherwise.

System 100 comprises a Recluder of Secrets (RoS) 104 and a repository 106. User 102 supplies a secret to RoS 104 through an enrolment process described in more detail below. RoS 104 records the secret and returns it to user 102 when user 102 makes a request for the secret thereby shifting the responsibility of storing the secret from user 102 to RoS 104.

RoS 104 comprises a plurality of servers 108, each configured to store a different share 110 of the secret. The servers each receive their share of the secret during the enrolment process. It will be appreciated that because each server 108 receives and stores a share of the secret that no one server is able to exploit the secret. The inability of a single server to exploit the secret significantly mitigates the risk taken by user 102 when providing the secret to RoS 104.

Each share 110 is stored in association with a unique identifier and a verifier which corresponds to the unique identifier. RoS 104 uses the unique identifier to distinguish between shares 110.

The nature of the share 110 and how it is generated is provided in more detail below.

Although FIG. 1 depicts shares 110 as being stored on a single repository 106, in practice they may be stored in any retrievable location. For example, in some embodiments, servers 108 record shares 110 locally on repositories accessible only to the individual servers. In other embodiments a subset of servers store shares 110 in a common repository while others store shares 110 locally. In another embodiment, repository 106 is a distributed ledger accessible by each server 108.

System 100 is compatible with all common encryption schemes, including but not limited to, ElGamal, Elliptic Curve cryptography systems and lattice based encryption techniques such as learning with errors (LWE) and NTRU.

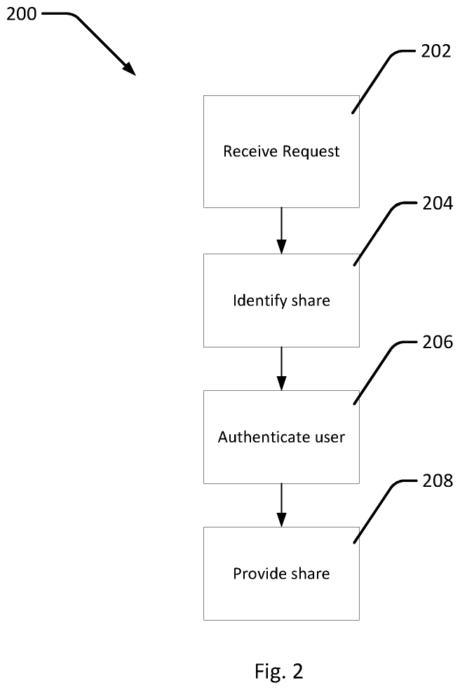

FIG. 2 illustrates a method 200 performed by each server 108 of RoS 104. As mentioned above, each server 108 stores a different share of a secret in association with a unique identifier and a corresponding verifier. The unique identifier is indicative of the owner of the secret and the corresponding verifier is used to authenticate the owner. Each share 110 of the secret having been generated from the secret by a deterministic or probabilistic cryptographic share generation method, which is discussed in more detail below.

At step 202, the server 108 receives a request from a user to provide the stored share to the user. The user makes the request to server 110 through a network using client device 102. The network may be any suitable communication network such as the internet, a local area network (LAN) or a wireless network using standard communication protocols. The request comprises a request identifier and a request verifier which the user provides through client device 102.

Server 110 then performs step 204, identifying the share stored by server 110 by comparing the request identifier with the unique identifier associated with the stored share. As mentioned above, the unique identifier associated with the stored share is indicative of the owner of the share and is therefore used to identify the appropriate share in repository 106.

At step 206, server 110 attempts to authenticate the user as the owner of the secret. This step requires server 110 to compare the request verifier, received with the user request at step 202, to the verifier corresponding to the unique identifier associated with the stored share. If the request verifier suitably compares to the verifier corresponding to the unique identifier, the user is authenticated as the owner of the secret.

If the user is authenticated as the owner of the secret, server 110 performs step 208 and provides the share identified in step 204 to the user. Server 110 provides the share to the user by transmitting the share over a network to user device 102. As mentioned above, the network may be any suitable communication network such as the internet, a local area network (LAN) or a wireless network using standard communication protocols.

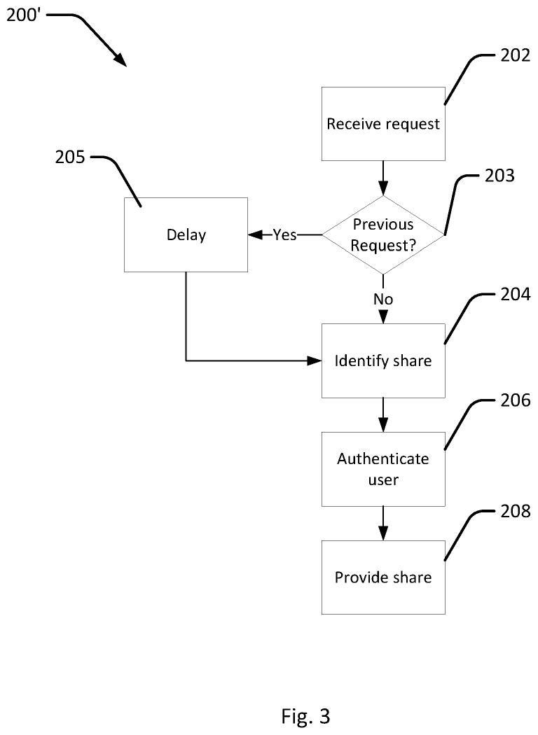

In some embodiments, each server 108 of RoS 104 performs method 200′ illustrated in FIG. 3. Method 200′ follows all the steps of method 200 which are illustrated here with matching reference numerals. In addition, method 200′ includes an analysis step 203 which compares the request received at step 202 to previously received requests. Specifically, step 203 compares the request identifier received with the most recent request at step 202 to request identifiers of previous requests. It will be appreciated that only previous requests made within a predetermined time period will be considered at step 203. For example, in some embodiments, only requests received at step 202 within the last hour will be considered as previous requests for the purposes of step 203.

If no previous requests comprised the same request identifier as the most recent request identifier, method 200′ proceeds to step 204.

If previous requests comprised the same request identifier as the most recent request identifier, method 200′ performs step 205 which comprises waiting for a delay period before moving to step 204. In some embodiments, the delay period increases with each subsequent request having the same request identifier. For example, the delay period may increase exponentially with each subsequent request having the same request identifier.

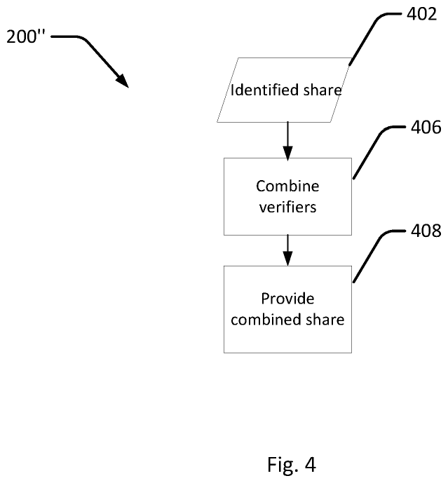

In some embodiments, each server 108 of RoS 104 performs method 200″ illustrated in FIG. 4. Method 200″ takes as input an identified share 402. Share 402 was identified by steps 202 to 205 of either method 200 or 200′. At step 406 of method 200″, server 108 combines the request verifier received at step 202 with identified share 402 and the verifier corresponding to the unique identifier associated with share 402 to define a combined share.

The combined share is then provided to the user at step 408 in a manner akin to step 208 of methods 200 and 200′. That is, the combined share is transmitted over a network to user device 102. As above, the network may be any suitable communication network such as the internet, a local area network (LAN) or a wireless network using standard communication protocols.

In some embodiments, server 108 defines the combined share, CS, as:

$$CS = \frac{{V}_{req} S}{V}$$

Where V_{req} is the request verifier, S is share 402 and V is the verifier corresponding to the unique identifier associated with share 402.

It will be appreciated that the combined share provided to the user at step 408 will be equivalent to share 402 if and only if the request verifier is the same as the verifier corresponding to the unique identifier associated with share 402.

In some embodiments, methods 200, 200′ and 200″ include an additional step of generating a record of the provision of share 110 or combined share to the user. This record may be stored on repository 106.

The secret may be any sensitive information that can be digitally represented, such as, for example, a private cryptographic key which will be used in the examples below.

### Enrolment

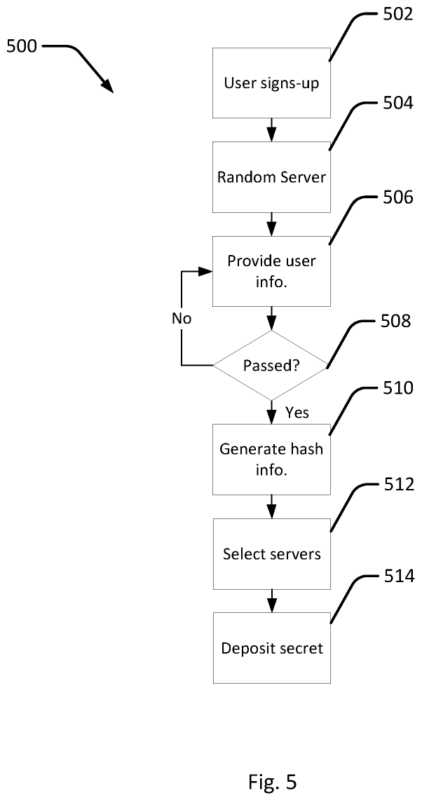

A user must enrol with system 100 before methods 200, 200′ or 200″ can be performed. The method 500 of enrolment is illustrated in FIG. 5.

Initially, at step 502, a user signs-up to use system 100. The sign-up process involves the user registering an interest in utilising system 100 to store and retrieve a secret on behalf of the user. The user registers this interest using client device 102 which communicates this interest to RoS 104 through a network. As above, the network may be any suitable communication network such as the internet, a local area network (LAN) or a wireless network using standard communication protocols.

The sign-up process at step 502 further comprises user device 102 establishing one or more auxiliary communication channels which can be used in the event that the password is forgotten or lost. An auxiliary channel may be an email account, a telephone number to receive data via a short message service (SMS), a smartphone application having a notification path on a wallet-like software, a computer that provides a file transfer protocol service or any other suitable communication channel.

The initial sign-up is received and processed by a randomly selected server 108 at step 504. The randomly selected server is responsible for ensuring that the enrolment is performed correctly. In some embodiments, the randomly selected server is selected using a round-robin selection process acting over all available servers. In other embodiments the server is selected by a mechanism defined by a party that the user intends to interact with.

The user then provides their user information at step 506. The user information comprises a unique identifier generated from a username, a verifier corresponding to the identifier and generated from of a password or a biometric of the user, and the secret to be stored by system 100. The username and password are provided by the user in the form of a first alphanumeric sequence and a second alphanumeric sequence respectively. In some embodiments the secret to be stored is not included in the user information. In other embodiments, the unique identifier is generated from a biometric of the user. As mentioned above, in this example, the secret is a private cryptographic key.

The randomly selected server then performs step 508 where it assesses the username and the corresponding password/biometric against predetermined criteria. For example, there is a requirement that the username be unique, and hence the randomly selected server will confirm that no such username is already utilised in system 100. It will be appreciated that the server performs the uniqueness test against a cryptographic hash of the username, rather than the username itself, the cryptographic hash having been generated by client device 102. The predetermined criteria for the password may be that it is required to be of a certain degree of complexity. In some embodiments, the corresponding password is assessed against the predetermined criteria by client device 102 rather than the server.

If the username and/or the password do not meet the predetermined criteria, method 500 returns to step 506 where the user is invited to supply an appropriate username and password that satisfies the predetermined criteria.

When an appropriate username and password is provided, client device 102 performs step 510, generating a cryptographic hash of the username and a cryptographic hash of the password or biometric. The cryptographic hash of the username will be used as the unique identifier stored in association with the share of the secret. Similarly, the cryptographic hash of the password or biometric will be used as the verifier corresponding to the unique identifier.

At step 512, servers 108 are selected to define the RoS 104. The details of the selection process are provided below.

Once servers 108 are selected, the secret provided at step 502 is deposited with RoS 104 along with the auxiliary communication channels' details. The process of depositing the secret is discussed in detail below in the section Depositing key fragments. In overview, the secret/key is split into shares, or fragments and provided to the servers 108 for storage in repository 106.

### Key Sharing

As mentioned above, a ‘share’ of a cryptographic key is deposited with each server 108 (or 1210 as described below). By depositing only a share with each server, the owner of the cryptographic key is able to store the key with the servers without having to trust the servers.

Each share of the key, also referred to as a fragment, is generated using verifiable client-side software known as a “wallet”. The wallet can split the key, α₀, into an arbitrary number of fragments using the polynomial:

f(x)=α₀+α₁x¹+α₂x²+ . . . +aₖ₋₁x^{k-1}

Where coefficients α₁ to αₖ₋₁ can be assigned randomly. The order of the polynomial determines a threshold number of fragments required to use the key and is a design parameter of the system. The greater the threshold number, the more servers are required to return a partially actioned digital object and therefore the more secure the key is. In this particular example, the threshold number of fragments required is k.

A fragment is generated by evaluating f(x) for a given value of x. As mentioned above, an arbitrary number of fragments can be generated in this fashion. However, it is a requirement that at least the threshold number of fragments are generated from unique x values. That is, f(x) is evaluated for at least k unique values of x. The fragments are then deposited with the servers using the method outlined below.

It will be appreciated that other key splitting techniques can be used to generate the key fragments. For example in some embodiments Feldman's secret sharing technique is used, while in other embodiments Pederson's secret sharing technique is used. In yet further embodiments, Stadler's secret sharing technique is used.

### Selecting the Servers

Step 512 of FIG. 5 requires the selection of a plurality of servers 108 to act as RoS 104. There are a number of options available for selecting servers 108, each of which are designed to improve the robustness and/or security of system 100. In practice, the options selected will be application specific and determined by the design requirements of that application. The options include:
Selecting a number of servers in excess of the threshold number;
Selecting servers from diverse geographical locations;
Selecting servers from a large pool of potential servers;
Randomly selecting one or more of the servers;
Selecting servers owned by different entities; and
Allowing the owner of the cryptographic key to select a portion of the servers.

The minimum number of servers 108 that can form RoS 104 is the threshold number. However, in practice the number of servers 108 is usually greater than the threshold number. Doing this creates redundancy in RoS 104, increasing the robustness of system 100 in the event that some servers 108 become non-responsive for whatever reason.

A further measure to improve robustness is to select a first portion of servers 108 from a first geographical location and a second portion of servers 108 from a second geographical location. This improves the robustness because it reduces the possibility that an event, whether man-made or natural, can disable enough servers such that RoS 104 is unable to function. Distributing the servers over a geographical region also has the effect of improving security as it reduces the likelihood that a malicious agent is able to capture a threshold number of servers.

Selecting servers 108 from a pool of potential servers improves the security of system 100. The security is improved because a malicious agent seeking to take possession of a cryptographic key would not easily discover which servers form RoS 104 for that cryptographic key.

Similarly, randomly selecting one or more of the servers reduces the ability of a malicious agent to identify which servers form RoS 104 for that cryptographic key.

Selecting servers owned and/or administered by different entities can further improve security of system 100. Having diverse ownership of servers 108 increases the difficulty of achieving malicious collusion between a threshold number of servers.

Allowing the owner of the cryptographic key to select a portion of servers 108 can also improve security. This option can be reduce the likelihood of a malicious agent capturing a threshold number of servers as the owner is able to select trusted servers.

In some embodiments, a third party is also able to select a portion of the servers. For example, consider a third party responsible for storing data encrypted with the owners cryptographic key. This third party also has an interest in selecting secure servers since it is responsible for the safety of the stored data. In this case, both the owner and the third party are able to select servers in such a way that a malicious agent would have to capture at least one server selected by the owner and one selected by the third party. Consider that from a total of n servers with a threshold value of t, both the owner and third party can select v servers where v is given by:

v=n−t+1

So, if there 20 total servers with a threshold of 14, both the owner and the third party are able to pick 7 servers with the remaining 6 selected at random from the pool. For a malicious agent to capture 14 servers (the minimum required to use the key), it would need to capture at least one of the servers selected by the owner and one selected by the third party.

### Depositing Key Fragments

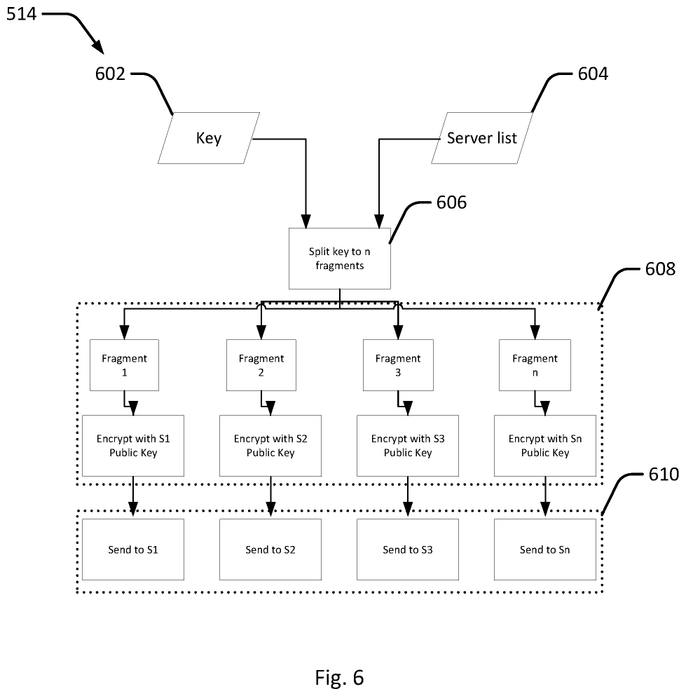

Step 514 of method 500 requires the secret/cryptographic key to be deposited with servers 108. An exemplary method 514 for achieving this is illustrated in FIG. 6. As mentioned above, the cryptographic key 602 to be stored with servers 108 is supplied by user device 102. The cryptographic key 602 can be either a symmetric key or a private key if an asymmetric cryptographic protocol is used, however the process is not limited to cryptographic keys, but could be any sensitive information.

In the case of a cryptographic key, it is generated by user device 102 executing a key generation algorithm according to the following process. Given (P, Q, g, sk, pk) are the values that are used to represent the keys, with the system parameters (P, Q, g) being an instance of the Discrete Logarithmic Problem (DLP) collection, i.e., P is a uniformly chosen prime and g is a uniformly chosen generator of the subgroup G_{Q} of prime order Q of [symbol] ₚ, where Q=(P−1)/γ is prime and γ is a specified small integer.

The key generating algorithm receives input (P, Q, g), and outputs a public key, e=(P, Q, g, pk), and a private key, d=(P, Q, g, sk), where:
sk is a uniformly chosen element of [symbol] .
pk ≡g^{sk} (mod P).

A list 604 of servers 108 for storing the key fragments is also provided. The server 108 were selected at step 512 described above. In this example, a total of n servers are selected.

Key fragments are then generated at step 606 using the methodology discussed above. In this example, n fragments are generated, one for each of the n selected servers 108 in list 604. As mentioned above, n must be at least as great as the threshold number k required for applying the key. Each key fragment has a designated server 108.

To use this (k, n) threshold scheme to share the secret sk without any loss of generality, it is needed to choose k−1 positive random integers in the finite field [symbol] of [symbol] α₁, . . . , αₖ₋₁ where α₀=sk and 0<k≤n<Q. Build the polynomial f(x)=α₀+α₁x+α₂x²+α₃x³+ . . . +aₖ₋₁x^{k-1}. Construct any n fragments out of it, for instance with the set of i=1, . . . , n it can be obtained that the fragment are a tuple of (i, f(i))=(xᵢ,yᵢ).

At step 608, each key fragment is encrypted using a public key of its designated server. Encrypting each fragment using the public key of the server ensures that only the designated server has access to that key fragment. In some embodiments, the key fragments are not encrypted, in which case their security relies on the security of the server's data storage. In some embodiments, the key fragments are encrypted by the designated server using a symmetric key of that designated server.

The encrypted key fragments are then transmitted to their designated servers 108 at step 610.

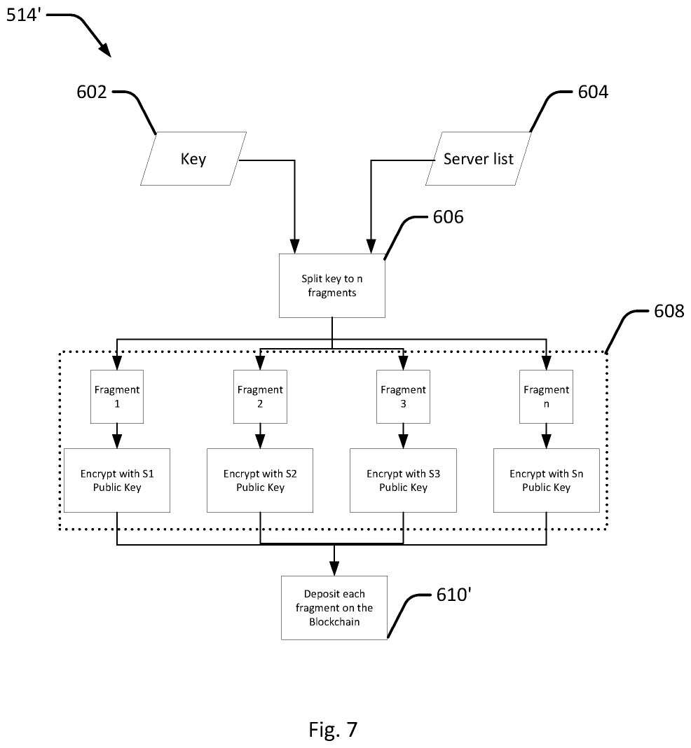

An alternative embodiment is shown as method 514′ in FIG. 7. The initial steps of method 514′ are the same as that of method 514 and will not be repeated here. However, step 610 of method 514 is replaced in method 514′ with step 610′. At step 610′, the encrypted key fragments are deposited onto a distributed ledger or blockchain. Servers 108 are then able to access the key fragments from the distributed ledger and decrypt them when required. It will be appreciated that in this embodiment, key fragments must be encrypted with a public or symmetric key of the designated server to avoid malicious access to them.

### Retrieving Secret

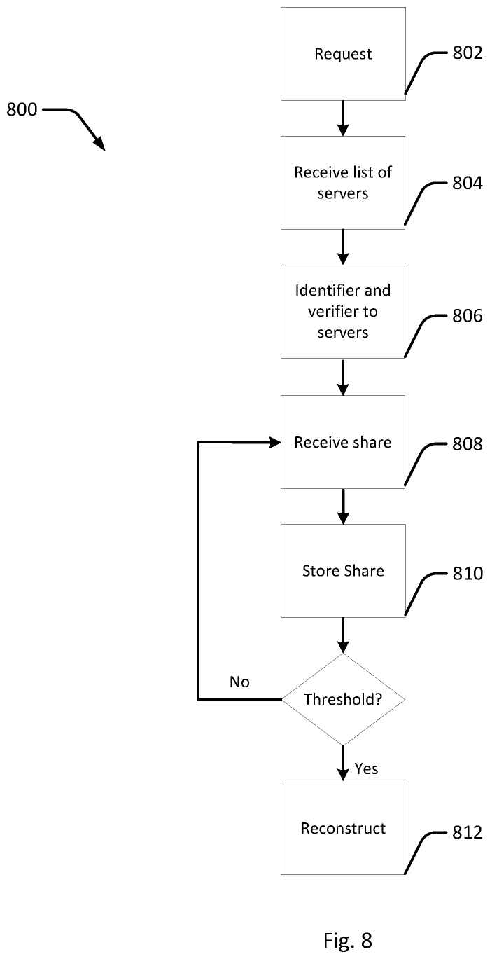

An owner of a secret wishing to retrieve that secret from RoS 104 performs method 800 of FIG. 8 using user device 102.

At step 802, the owner makes a request to RoS 104 to return the secret. The request is transmitted to RoS 104 through a network as described above. The request comprises the owner's unique identifier and corresponding verifier which are generated by device 102. Device 102 generates the unique identifier and corresponding verifier by creating a cryptographic hash of the user's username and password, similar to step 510 of method 500.

A randomly selected server receives the request and uses the unique identifier as an index to identify which servers 108 were selected at step 512 when the owner enrolled. The randomly selected server returns the list 604 of servers to device 102 at step 804.

When list 604 is received by user device 102, user device performs step 806 by transmitting the unique identifier and corresponding verifier to each of the servers 108 on list 604. Each of these servers then perform one of methods 200, 200′ or 200″ which results in each server returning a share of the secret to user device 102.

At step 808, user device 102 receives shares from servers 108. As the shares are received, they are stored at step 810. Device 102 accumulates shares in this manner until a threshold number of different shares have been received. In some embodiments, the servers 108 encrypts the shares using the owner's public key before providing them to the owner. In this case, the owner is able to decrypt each share using the corresponding private key.

Step 812 is performed when a threshold number of shares is received by user device 102. This step involves user device 102 reconstructing the secret from the threshold number of different shares. For example, if the threshold number is k and the shares are represented by (x₀, y₀), . . . , (xₖ, yₖ) where no xᵢ are the same, the secret shared is reconstructed with the interpolation of a polynomial in the Lagrange for L(0):

$$L ( 0 ) = {\sum }_{i = 1}^{k} {y}_{i} {l}_{l} ( x ) ( mod Q ) \\ {l}_{i} ( x ) = {\prod }_{{j = 1}_{j \neq i}}^{k} \frac{{x}_{j}}{{x}_{j} - {x}_{i}} ( mod Q ) \qquad$$

### Server-Specific Verifiers

As discussed above with reference to FIG. 5, the unique identifier and corresponding verifier are generated by performing a cryptographic hash of the username and password respectively.

While this hash is not the actual password, having this information could potentially allow a malicious server to get all the other servers 108 to provide their shares of the secret and then subsequently assemble the secret.

This issue above is made much more prominent when considering that passwords are mostly not made of random data. Passwords are usually a rather predictable set of words and character sequences. For example, 3% of all passwords in the world are this string: “12345”. Therefore, malicious agents can utilize an attack vector called “Dictionary attack” on someone's specific password by going through a big list of all known passwords (aka dictionary) and finding a match. A malicious server operator can exercise a dictionary attack on its own database and locate hashed passwords/verifiers that match those in the dictionary—and by that acquire the full password which can be used to get all the other servers 108 to provide their shares of the secret.

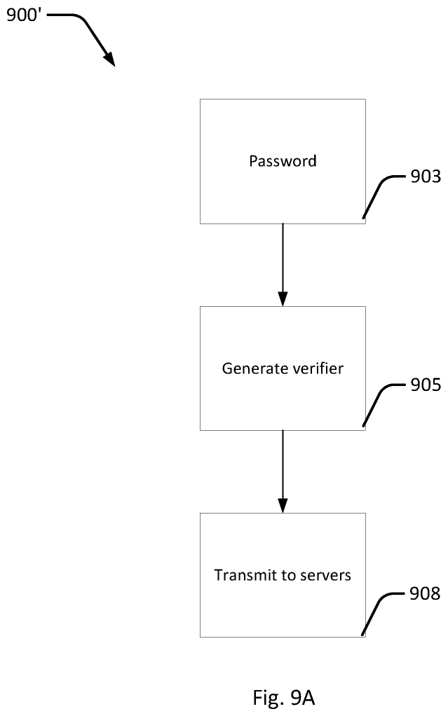

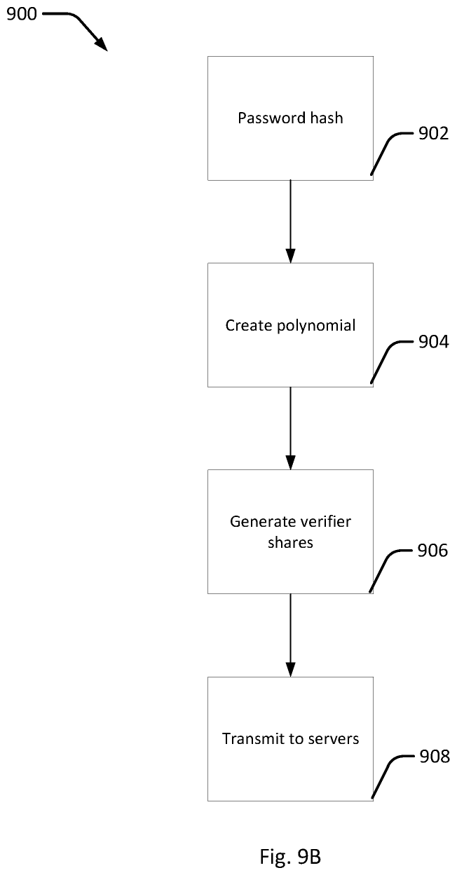

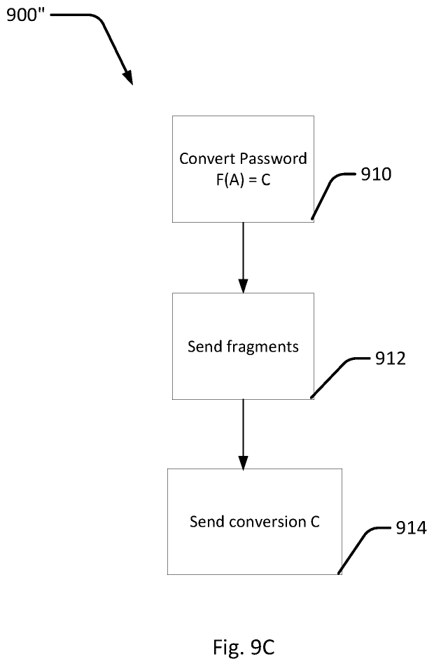

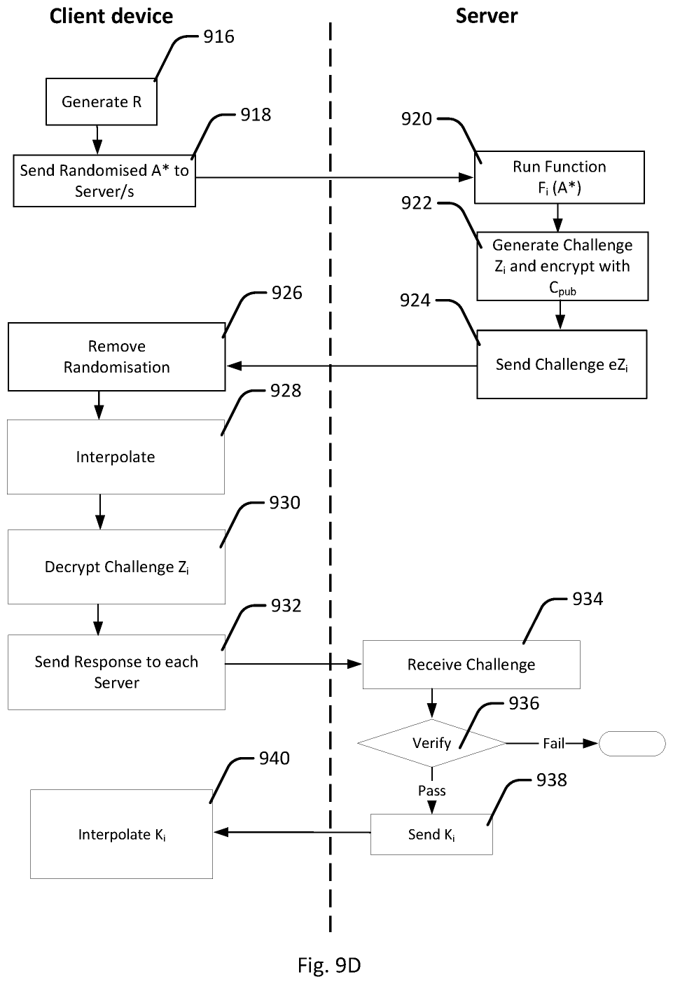

To address this, some embodiments include further steps when generating the corresponding verifier. This process is shown in a generalised form as method 900′ of FIG. 9A. Method 900′ is performed by client device 102 during an initial enrolment period. At step 903, a user of client device 102 provides a password. At step 905, a verifier to be stored on the servers 108 is generated and transmitted to the servers 108 at step 908. At a later time, servers 108 can utilise the stored verifiers, received at step 908, to authenticate a user seeking access to that servers share 110 of the cryptographic key.

A specific example of this is shown as method 900 of FIG. 9B. In overview, method 900 creates different shares of the verifier for each server 108 of RoS 104. The shares are generated in a deterministic or probabilistic way such that user device 102 will always be able to recreate the specific share for a specific server given the password as an input.

Initially, at step 902 a cryptographic hash of the password or biometric is generated. The output is equivalent to the verifier described in the examples above. In some circumstances, using the hash of the password or biometric can create a security issue.

At step 904, the cryptographic hash is used to create a polynomial of order k where k is the threshold number of servers. The polynomial is created by splitting the password hash into a number of fragments which define the coefficients of the polynomial. For example, if step 902 generates a 256 bit hash, the hash can be represented by: Hash=α₀α₁ . . . α₃₁ where each αᵢ is an 8 bit number. A polynomial, P, can then be generated using the fragments of the password hash:

P(x)=α₀+a₁x+a₂x²+ . . . α₃₁x³¹

The polynomial P is then used in step 906 to generate server-specific verifiers for each server. This is achieved by evaluating P for a different value of x for each server. As this process must be deterministic to be repeatable, some property of each server is used for the domain of P. For example, in some embodiments the servers' public keys form the domain of P. In other embodiments, the servers' IP addresses for the domain of P. The outputs of P evaluated for each server, is used a server specific verifier.

The server specific verifiers generated at step 906 are then transmitted to the relevant server at step 908. In some embodiments, the finite field of the verifier calculated above is reduced to create a superfluity of identical repetitions of shares amongst many different passwords. That is, each server will receive a share which could have been generated by many different passwords making it impractical for a malicious server to derive the password from the verifier. For example, the finite field may be reduced to 8 bits (or 256 combinations), each of which could be generated by many possible passwords. The combination of all verifiers taken together, however, could only be generated by a single password.

Method 900 is used in place of step 510 of method 500 when a user is enrolling with system 100. Similarly, device 102 performs method 900 during step 806 of method 800 when a user wishes to retrieve the secret.

It will be appreciated that method 900 avoids the situation where a server is in possession of a complete verifier which any other servers 108 or RoS 104 will be using. That is, method 900 ensures that there is no single verifier, but rather each server only has a server-specific verifier. This creates the advantage that none of the severs are in possession of the complete verifier (if there were only one).

A further example of generating a verifier is shown as method 900″ in FIG. 9C. Method 900″ is performed by client device 102 during an enrolment process. At step 910, a user of client device 102 provides a password A, which is converted to a conversion key C by a function F. That is to say, conversion key C is found by evaluating function F for password A such that F(A)=C.

A public key, C_{pub}, is then generated using cryptographic key generation methods acting on C. For example, the public key can be found using C_{pub}=G^{C}.

At step 912, shares of function F are generated and provided to servers 108 along with shares 110 of the cryptographic key, K. The i^{th} server will receive the i^{th} share/fragment of F, denoted Fᵢ, and the i^{th} share/fragment of the cryptographic key, denoted Kᵢ. Suitable share generation methods are described in detail above and will not be repeated here.

At step 914 the public key, C_{pub}, of conversion key C, is provided to each server. After execution of step 914, the i^{th} server will have received Fᵢ, Kᵢ and C_{pub} from client device 102. These values are used at later times to verify a password as described below with reference to FIG. 9D.

It will be appreciated that method 900″ prevents any server from accessing or storing the user's password, A, or secret/cryptographic key, K.

Method 900′″ of FIG. 9D illustrates a verification process for situations where verifiers are generated using method 900″.

At step 916, a user of client device 102, seeking to access a share 110, Kᵢ, of cryptographic key, K, from the i^{th} server, provides a password, A. Client device 102 then randomises A in a reversible process denoted R(A) and provides R(A) to the servers at step 918. An example of a reversible randomising process is to raise A to the power of a random number R. That is R(A)=A^{R}.

At step 920, each server receives R(A) and evaluates its share of function F taking R(A) as input. For example, the i^{th} server calculates Fᵢ(R(A)).

The servers 108 then execute step 922, which involves generating a random challenge Zᵢ and encrypting it with the public key of C, C_{pub}. The encrypted challenge, denoted Enc(Zᵢ, C_{pub}), is returned to client device 102 at step 924 along with its evaluated share of function F. That is, the i^{th} server returns, to client device 102, Fᵢ(R(A)) and Enc(Zᵢ, C_{pub}).

Client device 102 executes step 926 upon receiving Fᵢ(R(A)) and Enc(Zᵢ, C_{pub}) from at least a threshold number of servers. Step 926 involves reversing the randomisation applied at step 916 for each Fᵢ(R(A)) received. For the example where R(A)=A^{R}, step 926 will be evaluating Fᵢ(R(A))^{(1/R)} for each Fᵢ(R(A)). The result of the evaluation will be Fᵢ(A) (as the randomisation, R, has been reversed).

If n servers 108 executed steps 920 to 924, client device 102 will have a series of values F₁(A), F₂(A) . . . Fᵢ(A) . . . Fₙ(A) after step 926. The series of values, F₁(A), F₂(A) . . . Fᵢ(A) . . . Fₙ(A), are then interpolated at step 928 to yield F(A) using interpolation methods described in detail above. As described above, conversion key C is defined as F(A)=C.

Client device 102 then executes step 930, decrypting the random challenge for each server using conversion key C. For example, the i^{th} challenge, Zᵢ, from the i^{th} server will be decrypted using Zᵢ=Dec(Enc(Zᵢ, C_{pub}), C). Client device 102 will therefore have a random challenge for each server 108.

At step 932, client device 102 returns each random challenge to the appropriate server. That is, client device 932 will provide challenge Zᵢ, to the i^{th} server.

Step 934 is executed by each server 108. Each server receives the challenge sent from client device 102 at step 932. Each server then attempts to verify the password at step 936 by comparing the received challenge to the random challenge it generated at step 922. If the received challenge matches the randomly generated challenge from step 922, the password is verified and the server executes step 938 by providing its share 110 of cryptographic key, K to client device 102. For example, the i^{th} server will provide key fragment Kᵢ to client device 102.

If the password, A, is authenticated, client device 102 will receive key fragments from each of servers 108 and then executes step 940 by interpolating the key fragments to yield key K.

### Forgotten Password Protocol

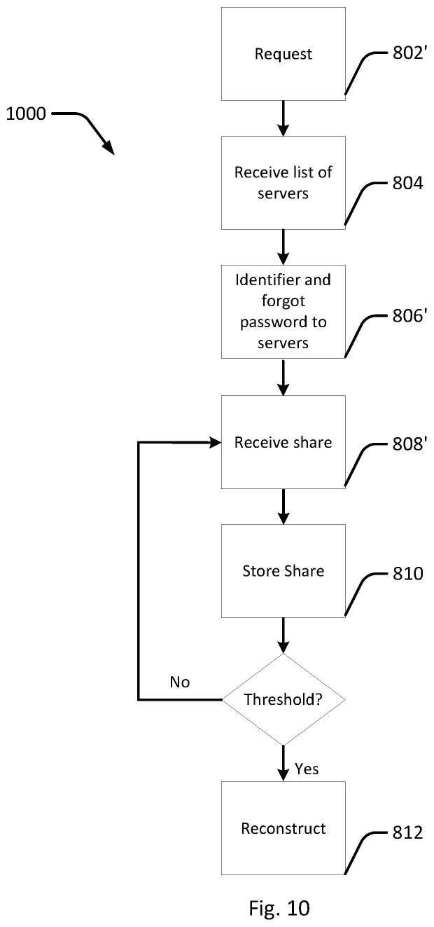

In some circumstances, an owner of a secret may lose or forget their password. In this case, method 1000, illustrated in FIG. 10 can be used to retrieve the secret stored by RoS 104. Method 1000 is similar to method 800 used to retrieve a secret.

At step 802′ the owner makes a request to RoS 104 using device 102, the request comprising a password recovery request indicating that the password has been lost or forgotten. The request further comprises the owner's unique identifier generated by device 102 as described for other methods above. Device 102 generates the unique identifier by creating a cryptographic hash of the user's username.

A randomly selected server receives the request and uses the unique identifier as an index to identify which servers 108 were selected at step 512 when the owner enrolled. The randomly selected server returns the list 604 of servers to device 102 at step 804.

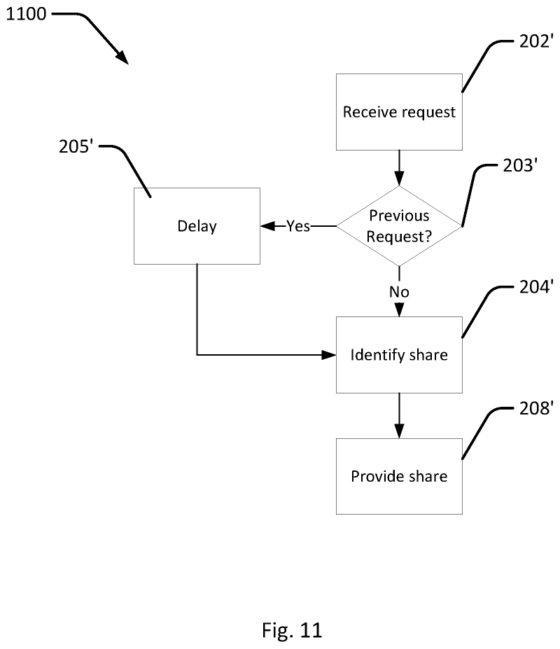

When list 604 is received by user device 102, user device 102 performs step 806′ by transmitting the unique identifier and the password recovery request to each of the servers 108 on list 604. Each of these servers then perform method 1100 of FIG. 11 which results in each server returning a share of the secret to user device 102 via the one or more auxiliary channels established during enrolment.

At step 808′, user device 102 receives shares from servers 108. As mentioned above, these shares are received through the one or more auxiliary channels. In some embodiments, the user is required to manually copy the shares from the one or more auxiliary channels to an application on user device 102. The application comprises computer executable instructions for performing step 812. In other embodiments the shares are automatically copied to the application.

As the shares are received from the one or more auxiliary channels, they are stored at step 810. Device 102 accumulates shares in this manner until a threshold number of different shares have been received. In some embodiments, the servers 108 encrypts the shares using the owner's public key before providing them to the owner. In this case, the owner is able to decrypt each share using the corresponding private key.

Step 812 is performed when a threshold number of shares is received by user device 102. This step involves user device 102 reconstructing the secret from the threshold number of different shares. For example, if the threshold number is k and the shares are represented by (x₀, y₀), . . . , (xₖ, yₖ) where no xᵢ are the same, the secret shared is reconstructed with the interpolation of a polynomial in the Lagrange for L(0):

$$L ( 0 ) = {\sum }_{i = 1}^{k} {y}_{i} {l}_{l} ( x ) ( mod Q ) \\ {l}_{i} ( x ) = {\prod }_{{j = 1}_{j \neq i}}^{k} \frac{{x}_{j}}{{x}_{j} - {x}_{i}} ( mod Q ) \qquad$$

As mentioned above, each of the servers of RoS 104 performs method 1100 of FIG. 11 in response to receiving the unique identifier and the password recovery request.

At step 202′, the server 108 receives the request generated at step 802′ of method 1000 through a network. The network may be any suitable communication network such as the internet, a local area network (LAN) or a wireless network using standard communication protocols. As above, the request comprises a password recovery request indicating that the password has been lost or forgotten and the owner's unique identifier generated by device 102 as described for other methods above.

Method 1100 then performs analysis step 203′ which compares the request received at step 202′ to previously received requests. Specifically, step 203′ compares the request identifier received with the most recent request at step 202′ to request identifiers of previous requests. It will be appreciated that only previous requests made within a predetermined time period will be considered at step 203′. For example, in some embodiments, only requests received at step 202 within the last hour will be considered as previous requests for the purposes of step 203.

If no previous requests comprised the same request identifier as the most recent request identifier, method 100 proceeds to step 204′.

If previous requests comprised the same request identifier as the most recent request identifier, method 1100 performs step 205′ which comprises waiting for a delay period before moving to step 204′. In some embodiments, the delay period increases with each subsequent request having the same request identifier. For example, the delay period may increase exponentially with each subsequent request having the same request identifier.

Server 108 then performs step 204′, identifying the share stored by server 108 by comparing the request identifier with the unique identifier associated with the stored share. As mentioned above, the unique identifier associated with the stored share is indicative of the owner of the share and is therefore used to identify the appropriate share in repository 106.

Server 108 then performs step 208′ and provides the share identified in step 204′ to the user through the one or more auxiliary channels. Server 108 provides the share to the user by transmitting the share over a network to user device 102. As mentioned above, the network may be any suitable communication network such as the internet, a local area network (LAN) or a wireless network using standard communication protocols.

### Overview: Automated Delegated Trustee

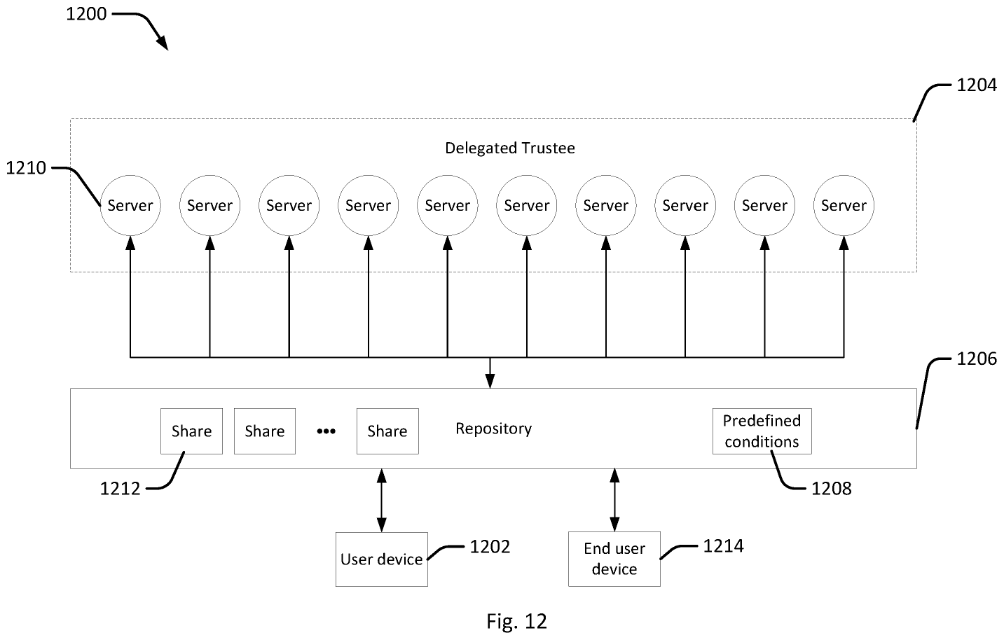

A system 1200 for allowing a user, operating user device 1202, to delegate authority over their cryptographic key is illustrated in FIG. 12. The user will be represented by user device 1202 and the terms will be used interchangeably throughout.

System 1200 comprises a delegated trustee 1204 and a repository 1206. User 1202 delegates authority over the cryptographic key to delegated trustee 1204, which is authorised to use the key when predefined conditions 1208 are met. User 1202 records predefined conditions 1208 in repository 1206 which is readable by delegated trustee 1204.

Delegated trustee 1204 comprises a plurality of servers 1210, each configured to store a different share 1212 of the cryptographic key. It will be appreciated that because each server 1210 only receives a share, or fragment, of the key, no one server is able to exploit the key. The inability of a single server to exploit the key significantly mitigates the risk that user 1202 takes when sharing the key with servers 1210. The nature of the share 1212 and how it is generated is provided in more detail above and will not be repeated here. An end user, represented by end user device 1214 is able to communicate with system 1200, either through repository 1206 storing predefined conditions 1208, or via a suitable network (not shown).

It will be appreciated that each server 1210 stores a share 1212. Although FIG. 12 depicts shares 1212 as being stored on repository 1206, in practice they may be stored in any retrievable location. For example, in some embodiments, servers 1210 record shares 1212 locally on repositories accessible only to the individual servers. In other embodiments, servers 1210 store shares 1212 on a secondary repository, distinct from repository 1206 where predetermined conditions 1208 are stored.

Repository 1206 is a distributed ledger which allows user 1202 to record predefined conditions 1208 in a substantially trustless manner. That is, user 1202 is not required to trust any one party to faithfully store predefined conditions 1208. Rather, system 1200 utilises the inherent properties of distributed ledgers, such as their accessibility and robustness to tampering and alteration, to enable user 1202 to provide predefined conditions 1208 to delegated trustee 1204 from a single location. Thus, ledger 1206 acts as a messaging bus giving the effect of a “central-like” point of access for user 1202 to interact with delegated trustee 1204.

Predefined conditions 1208 specify conditions under which delegated trustee 1204 is able to perform authoritative transactions on user's 1202 behalf. For example, predefined conditions 1208 may be a smart contract which defines rules and penalties around an agreement and automatically enforces the obligations. For example, the smart contract may stipulate conditions that must be met by a third party for user 1202 to pay that third party. Delegated trustee 1204 determines whether the predefined conditions are satisfied, and, if they are, performs the authoritative transaction. In this example, that involves delegated trustee 1204 utilising user's 1202 key to authorise payment.

In a second example, predefined conditions 1208 stipulate that, upon payment from a third party, user 1202 is to provide an electronic file. Before the transaction, the file is encrypted to prevent third parties from gaining unauthorised access. After payment is confirmed by delegated trustee 1204, delegated trustee 1204 uses the key to decrypt the file and provides this to the third party. These processes are described in greater detail below.

In one embodiment, delegated trustee 1204 comprises a single server, and repository 1206 is a trustless repository such as a public blockchain. In this embodiment, the single server 1210 has access to the entire secret cryptographic key rather than just a share. The cryptographic key is encrypted with a public key of the server such that only the server is able to utlise the key. Predefined conditions 1208 are also stored on a trustless repository such as a blockchain although this is not necessarily the same blockchain as that used to store the cryptographic key. It will be appreciated that this embodiment will also allow for automated use of the cryptographic key but requires trust in the integrity of the server.

System 1200 is compatible with all common encryption schemes, including but not limited to, ElGamal, Elliptic Curve cryptography systems and lattice based encryption techniques such as learning with errors (LWE) and NTRU.

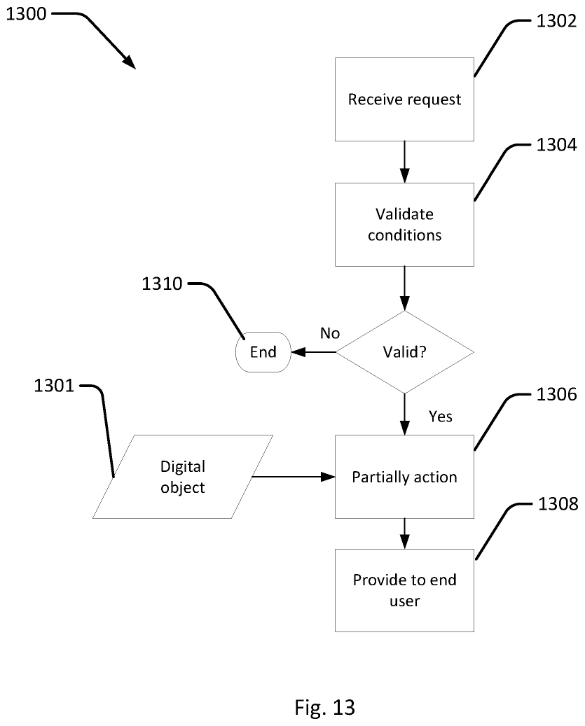

FIG. 13 illustrates a method 1300 performed by each server 1210 of system 1200 for automatically actioning a digital object 1301 using a cryptographic key of user 1202 on behalf of user 1202. The actioned digital object is provided to an end user. As mentioned above, each server 1210 stores a different share of a cryptographic key 1212.

At step 1202, server 1210 receives a request to action digital object 1201 using the cryptographic key. The request may be received over a network, having originated from either user device 1202 or end user device 1214. The network may be any suitable communication network such as the internet, a local area network (LAN) or a wireless network using standard communication protocols. Actioning the digital object may be any process which can be achieved by applying a cryptographic key to a digital object. For example, actioning digital object 1301 may involve applying the key to digital object 1301 to decrypt it, to encrypt it, to sign it, certify it through generation of a certificate or any other action that can be taken with a cryptographic key. Depending on the nature of the application, the key may be either a symmetric key or the private key of a public key system and the request may come from either the end user, the owner of the key or some other interested party.

At step 1304, server 1210 determines whether one or more predefined conditions 1208 are satisfied. As discussed above, predefined conditions 1208 stipulate conditions under which server 1210 is authorised to apply the key and may be a smart contract or some other conditions provided by the owner of the key.

In the case where the one or more predefined conditions 1208 are satisfied, step 1306 is performed, wherein server 1210 partially actions digital object 1301 using the share of the cryptographic key. By applying the share of the key to digital object 1301, a partially actioned digital object is generated. The technical details of how a partially actioned digital object is generated are provided below.

After generation of the partially actioned digital object, step 1308 is performed wherein the partially actioned digital object is provided to end user 1214. The partially actioned digital object is provided to end user 1214 over a suitable communication network such as the internet, a local area network (LAN) or a wireless network using standard communication protocols.

In the case where the one or more predefined conditions 1208 are not satisfied, server 1210 takes no action as represented by end point 1310.

In some embodiments, the end user receives a plurality of partially actioned digital objects from a plurality of servers 1210. The end user then combines the partially actioned digital objects to reconstruct a fully actioned digital object.

### Depositing Key Fragments

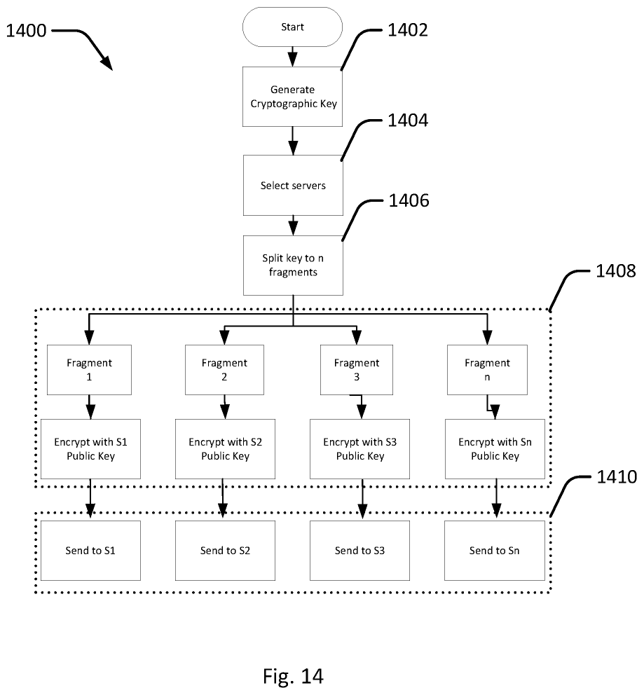

Methods 514 and 514′, described above, can be used for depositing key fragments. A further exemplary method 1400 for depositing key fragments with servers 1210 is illustrated in FIG. 14. Initially, at step 1402, the cryptographic key to be stored with servers 1210 is generated or supplied by user device 1202. As mentioned above, the key can be either a symmetric key or a private key if an asymmetric cryptographic protocol is used.

Formally, given (P, Q, g, sk, pk) are the values that are used to represent the keys, with the system parameters (P, Q, g) being an instance of the Discrete Logarithmic Problem (DLP) collection, i.e., P is a uniformly chosen prime and g is a uniformly chosen generator of the subgroup G_{Q} of prime order Q of [symbol] *ₚ, where Q=(P−1)/γ is prime and γ is a specified small integer.

The key generating algorithm receives input (P, Q, g), and outputs a public key, e=(P, Q, g, pk), and a private key, d=(P, Q, g, sk), where:
sk is a uniformly chosen element of [symbol] .
pk≡g^{sk} (mod P).

At step 1404, a plurality of servers 1210 are selected for storing the key fragments. There are a number of considerations to take into account when selecting servers, discussed in more detail below. It will be appreciated that the order of steps 1402 and 1404 is unimportant, and in some embodiments step 1404 is performed before step 1402. In this example, a total of n servers are selected.

Key fragments are then generated at step 1406 using the methodology discussed above. In this example, n fragments are generated, one for each of the n selected servers 1210. As mentioned above, n must be at least as great as the threshold number k required for applying the key. Each key fragment has a designated server 1210.

To use this (k, n) threshold scheme to share the secret sk without any loss of generality, it is needed to choose k−1 positive random integers in the finite field [symbol] of [symbol] α₁, . . . , αₖ₋₁ where α₀=sk and 0<k≤n<Q. Build the polynomial f(x)=α₀+α₁x+α₂x²+α₃x³+ . . . +αₖ₋₁x^{k-1}. Construct any n fragments out of it, for instance with the set of i=1, . . . , n it can be obtained that the fragment are a tuple of (i, f(i))=(xᵢ,yᵢ).

At step 1408, each key fragment is encrypted using a public key of its designated server. Encrypting each fragment using the public key of the server ensures that only the designated server has access to that key fragment. In some embodiments, the key fragments are not encrypted, in which case their security relies on the security of the server's data storage. In some embodiments, the key fragments are encrypted by the designated server using a symmetric key of that designated server.

The encrypted key fragments are then transmitted to their designated servers 1210 at step 1410.

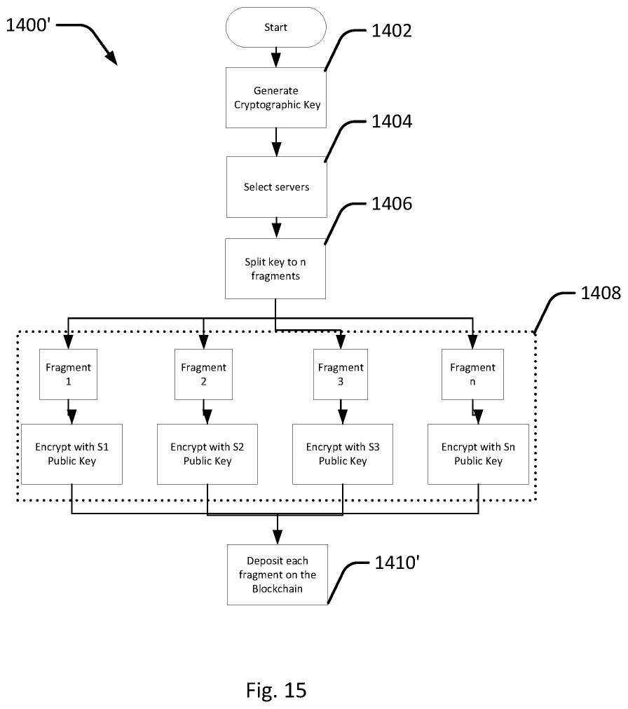

An alternative embodiment is shown as method 300′ in FIG. 15. The initial steps of method 1400′ are the same as that of method 1400 and will not be repeated here. However, step 1410 of method 1400 is replaced in method 1400′ with step 1410′. At step 1410′, the encrypted key fragments are deposited onto a distributed ledger or blockchain. Servers 1210 are then able to access the key fragments from the distributed ledger and decrypt them when required. It will be appreciated that in this embodiment, key fragments must be encrypted to avoid malicious access to them.

### Selecting the Servers

The process of selecting servers is described in detail above but will be described again here with updated references for the present application. Step 1404 of FIGS. 14 and 15 require the selection of a plurality of servers 1210 to act as delegated trustee 1204. There are a number of options available for selecting servers 1210, each of which are designed to improve the robustness and/or security of system 1200. In practice, the options selected will be application specific and determined by the design requirements of that application. The options include:
Selecting a number of servers in excess of the threshold number;
Selecting servers from diverse geographical locations;
Selecting servers from a large pool of potential servers;
Randomly selecting one or more of the servers;
Selecting servers owned by different entities; and
Allowing the owner of the cryptographic key to select a portion of the servers.

The minimum number of servers 1210 that can form delegated trustee 1204 is the threshold number. However, in practice the number of servers 1210 is usually greater than the threshold number. Doing this creates redundancy in delegated trustee 1204, increasing the robustness of system 1200 in the event that some servers 1210 become non-responsive for whatever reason.

A further measure to improve robustness is to select a first portion of servers 1210 from a first geographical location and a second portion of servers 1210 from a second geographical location. This improves the robustness because it reduces the possibility that an event, whether man-made or natural, can disable enough servers such that trustee 1204 is unable to function. Distributing the servers over a geographical region also has the effect of improving security as it reduces the likelihood that a malicious agent is able to capture a threshold number of servers.

Selecting servers 1210 from a pool of potential servers improves the security of system 1200. The security is improved because a malicious agent seeking to take possession of a cryptographic key would not easily discover which servers form delegated trustee 1204 for that cryptographic key.

Similarly, randomly selecting one or more of the servers reduces the ability of a malicious agent to identify which servers form delegated trustee 1204 for that cryptographic key.

Selecting servers owned and/or administered by different entities can further improve security of system 1200. Having diverse ownership of servers 1210 increases the difficulty of capturing a threshold number of servers.

Allowing the owner of the cryptographic key to select a portion of servers 1210 can also improve security. This option can be reduce the likelihood of a malicious agent capturing a threshold number of servers as the owner is able to select trusted servers.

In some embodiments, a third party is also able to select a portion of the servers. For example, consider a third party responsible for storing data encrypted with the owners cryptographic key. This third party also has an interest in selecting secure servers since it is responsible for the safety of the stored data. In this case, both the owner and the third party are able to select servers in such a way that a malicious agent would have to capture at least one server selected by the owner and one selected by the third party. Consider that from a total of n servers with a threshold value of t, both the owner and third party can select v servers where v is given by:

v=n−t+1

So, if there 20 total servers with a threshold of 14, both the owner and the third party are able to pick 7 servers with the remaining 6 selected at random from the pool. For a malicious agent to capture 14 servers (the minimum required to use the key), it would need to capture at least one of the servers selected by the owner and one selected by the third party.

### Example—Decrypting File

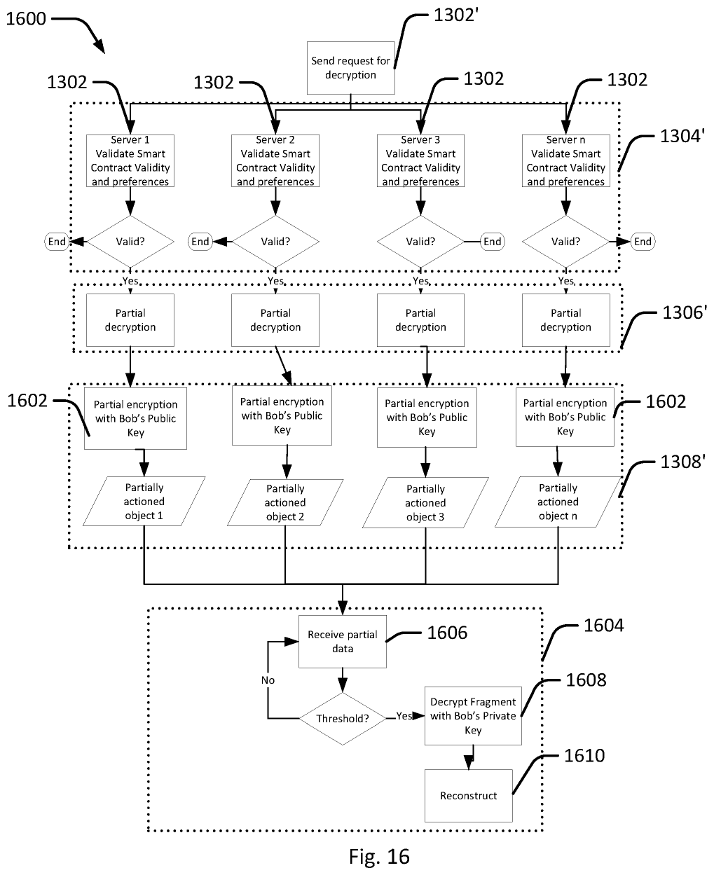

A more detailed example of delegated trustee 104 automatically decrypting a digital object will be described with reference to FIG. 16. In this example, the digital object is a data package. Method 1600 of FIG. 16 is performable by system 1200 of FIG. 12 on a data package that was created by encrypting a digital object m with encryption algorithm E. Algorithm E receives as input an owner's public key pk, digital object m∈G_{Q}, and (P, Q, g), uniformly selects an element γ in [symbol] and outputs an encrypted data package given by:

E((P,Q,g,pk),m)(g^{γ}(mod P),m×pk^{γ}(mod P))=(c₁,c₂)

Initially, at step 1302′ of method 1600, an end user makes a request for a data package to be decrypted with the owner's secret key corresponding to public key pk. The request is received by each server 1210 of trustee 1204 (here labelled servers 1 to n) as represented by arrow 1302. The request includes the encrypted data package.

In some embodiments, the request does not include the encrypted data package but rather provides an indication of the location of the data package such that trustee 1204 is able to locate and access the data package.

After receipt of the request, each server validates the end user's request by accessing relevant transaction history stored in a public blockchain. The use of the blockchain for recording transaction history ensures that the transaction history is valid and unaltered. For simplicity, the public blockchain will be described as being the same repository as repository 1206. However, in practice two or more repositories may be used to effect the decryption. The transaction history includes actions performed by the end user, for example payment of a specified amount to the secret key owner.

At step 1304′ of method 1600, the transaction history is cross referenced to predefined conditions 1208 stored in repository 1206. In the case where the predefined conditions are satisfied, such as the condition that a specified amount is paid to the owner of the secret key, trustee 1204 performs step 1306′: actioning the data package. In this example, the request was to action the data package by decrypting it and hence each server 1210 partially decrypts the data package using the fragment of the secret key stored on that server. The partial decryption algorithm PD, with input (P, xᵢ, yᵢ) and encrypted data package (c₁, c₂), outputs:

PD((P,xᵢ,yᵢ),(c₁,c₂))=(xᵢ,c₁^{yi}(mod P),c₂)=(xᵢ,sᵢ,c₂)

After each server 1210 has performed the partial decryption of the data package, step 1308′ is performed wherein the partially decrypted data package is supplied to the end user. Step 1308′ includes sub-step 1602 in which each server encrypts the partially decrypted data package with a public key belonging to the end user.

At step 1604, the end user receives the partially decrypted data packages and decrypts the data package. Step 1604 includes receiving the partially actioned data packages as sub-step 1606, decrypting the partially actioned data packages as sub-step 1608 and constructing the decrypted data package as sub-step 1610.

As mentioned, at sub-step 1606 the end user receives the partially decrypted data packages from the servers 1210 of automated trustee 1204. However, the end user cannot use the partially decrypted packages until at least the threshold number of partially decrypted packages is received. Therefore, the end user must accumulate at least the threshold number of partially decrypted packages before proceeding.

When the threshold number of partially decrypted data packages has been received, the end user performs sub-step 1608. As mentioned above, each of the partially decrypted packages has been encrypted using the public key of the end user. The end user then uses the corresponding private key to decrypt each of the packages.

At sub-step 1610 the end user reconstructs the decrypted data package from the threshold number of partially decrypted data packages. The method for reconstructing the data package is given below.

For a given set of k partially decrypted data packages (x₀, s₀, c₂), . . . , (xₖ, sₖ, c₂) where no xᵢ are the same, the digital object m can be reconstructed by combining the partially decrypted data packages in a suitable fashion. For example, the reconstruction can be effected with the interpolation of a polynomial in a modified Lagrange for c₁^{L(0)}:

$$L ( 0 ) = {\sum }_{i = 1}^{k} {y}_{i} {ℓ}_{i} ( x ) ( mod Q ) \\ {c}_{1}^{L ( 0 )} = {\prod }_{i = 1}^{k} {c}_{1}^{( {y}_{i} {ℓ}_{i} ( x ) )} ( mod P ) \\ {c}_{1}^{L ( 0 )} = {\prod }_{i = 1}^{k} {( {c}_{1}^{{y}_{i}} )}^{{ℓ}_{i} ( x )} ( mod P ) \\ {c}_{1}^{L ( 0 )} = {\prod }_{i = 1}^{k} {s}_{i}^{{ℓ}_{i} ( x )} ( mod P ) \qquad$$

With the interpolation of all the points c₁^{L(0)}=c₁^{sk}=s, the message m can be decrypted: m=c₂×s⁻¹ (mod P).

### Example—Controlling Access

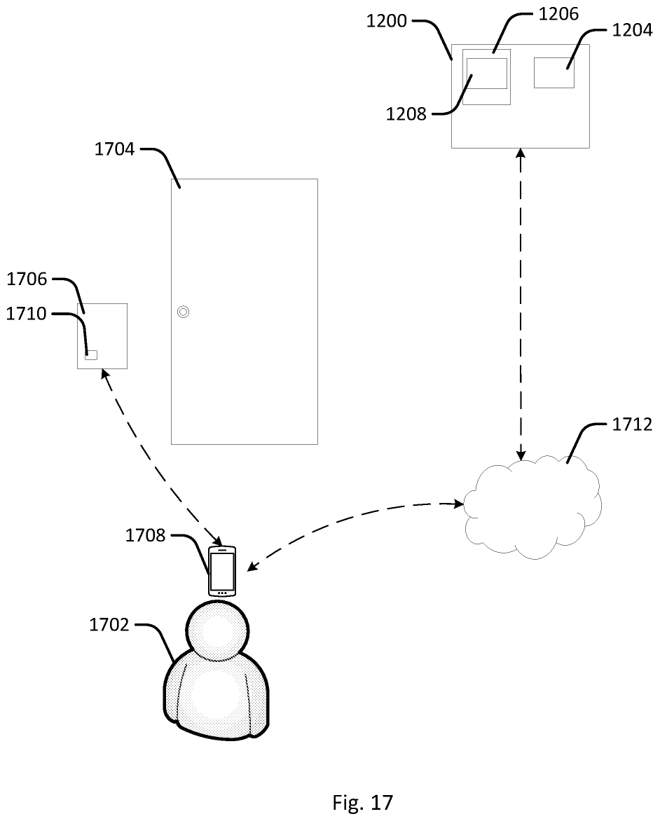

Another exemplary application of delegated trustee 1204 is to manage access to a facility, such as a holiday home will now be described with reference to FIG. 17. In this example, the method followed is similar to method 1600, with the main differences relating to the predefined conditions 1208 and the specifics of how the cryptographic key is applied to the digital object. In this example, delegated trustee 1204 is used to control access to a facility.

Initially, the owner deposits a private key with delegated trustee 1204 of system 1200 as described above in methods 1400 and 1400′. A visitor 1702 presenting at a point of entry 1704 to the facility is supplied with an ephemeral challenge through an interface 1706 at the point of entry. The challenge is received by a mobile client device 1708, such as a smart phone, belonging to visitor 1702. The challenge will be the digital object to be actioned by the delegated trustee 1204.

Interface 1706 includes a short range communication device 1710 to communicate with client device 1708. Short range communication device 1710 could be a Bluetooth Low Energy communication enabled device or device employing a Near Field Communication (NFC) protocol. The short range nature of the communications improves security as it ensures that visitor 1702 is physically present at access point 1704 at the time of making the request.

Visitor 1702 makes a request to trustee 1204 of system 1200 to be granted entry to the facility. The request includes the challenge and a unique identifier of the visitor, such as a public cryptographic key.

The request is transmitted to trustee 1204 through an external network 1712 such as a cellular communication network.

Trustee 1204 receives the request 1302 and seeks to validate 1304′ it against predefined conditions 1208 stored in repository 1206. In this case, predefined conditions includes a schedule of access, defining times at which specific visitors are authorised to have access to the facility. The schedule of access identifies visitors by unique identifiers such as public cryptographic keys. The visitor's request is validated when the request is made within the time frame recorded in the schedule of access for that visitor's unique identifier. That is, if the request is made during a time in which the visitor has reserved access. The predefined conditions may also include payment information such as whether the visitor has paid a required amount of money.

In the case where the request is validated, trustee 1204 actions the challenge. If the request is not validated, entry is denied. Actioning the challenge includes signing it with the owner's private key stored by trustee 1204. The signing process is similar to the decryption step 1306′ described with reference to FIG. 16, except that in this case each server 1210 partially signs the challenge with its share of the owner's private key. As with step 1602, the partially signed challenges are then encrypted using the public key of visitor 1702, which was also used to identify the visitor, and transmitted back to visitor 1702. In some embodiments, the partially signed challenge from each server is not encrypted but is rather transmitted back to visitor 1702 unencrypted.

Akin to steps 1608 and 1610, visitor 1702 waits until the threshold number of partially signed challenges has been received, and then decrypts them using the visitor's 1702 private key. The fully signed challenge is reconstructed from the partially signed challenges.

The visitor presents the signed challenge at access point 1706 which verifies the signed challenge with the owner's public key. If the signed challenge is successfully verified, access is granted to the visitor.

The owner's public key can either be stored at the access point or the interface could access it through a network.

### Example—Digital Power of Attorney

Another exemplary application of delegated trustee 1204 is to manage access to a facility, such as a holiday home. As above, in this example the method followed is similar to method 1600, with the main differences relating to the predefined conditions 1208 and the specifics of how the cryptographic key is applied to the digital object. In this example, delegated trustee 1204 is used as a digital power of attorney, with the ability to sign documents on the owner's behalf and specifically to authorise payments from a consumer to a supplier.

Initially, the owner/supplier deposits a private key with delegated trustee 1204 as described above in methods 1400 and 1400′. The supplier further provides predefined conditions 1208 in the form of a smart contract which allows the supplier to draw down on $10,000 order on specific milestones in small, time based instalments while completing a project.

Upon reaching a milestone, the supplier makes a request to trustee 1204 for payment of $1,500. The request includes the supplier's public key, acting as an identifier, the drawdown amount (being $1,500) in a payment approval binary request message and a milestone identifier. The mile stone identifier may be generated by, for example, a quality assurance system established for the project. In this case, the payment approval form is the digital object to be actioned.

Trustee 1204 receives the request and verifies 1304′ it against the predefined conditions 1208 in the smart contract. In the case where the request is verified, trustee 1204 actions 1306′ the payment approval by signing it with the consumer's private key. As with the previous examples, each server partially signs 1306′ the payment approval and encrypts the resulting digital object 1602 with the supplier's public key.

The partially signed approvals are transmitted 1308′ to the supplier. The supplier waits until a threshold number of partially signed approvals are received 1608 and then decrypts 1608 them using the supplier's private key. The signed approval is then reconstructed 1610 from the partially signed approvals. The supplier is then able to use the signed payment approval to complete the payment process.

### Example—Transactions with Data

Another exemplary application of delegated trustee 1204 is to automate sales of data. For example, the data may be private consumer data collected by a vendor relating to a particular consumer. Presently, vendors holding such data sell this data to third parties without the consumer's consent, a practice which some view as an invasion of privacy. Other's hold the view that the data is the property of the consumer and therefore the vendor has no right to sell it. However, the data also presents a risk to the vendor, who has to store the data and protect it from malicious entities trying to access it.

A solution to these problems can be achieved by using a public key belonging to the consumer to encrypt the data on the vendor's data base. This significantly reduces the risk to the vendor as it is now extremely unlikely that a malicious entity would be able to access the data. The encryption also prevents the vendor from selling the data without the permission of the consumer as decryption of the data requires use of the consumer's private key. System 1200 can be used to make transactions with the data to the benefit of both the consumer and the vendor by using method 1600 of FIG. 16.

In this case, the digital object is the consumer data or data package stored on the vendor database. The consumer data is encrypted with the public key of the consumer.

Initially, at step 1302′ of method 1600, the third party makes a request for the consumer data to be decrypted with the consumer's private key stored in trustee 1204. The request is received by each server 1210 of trustee 1204 (here labelled servers 1 to n) as represented by arrow 1202.

The request provides an indication of the location of the consumer's data in the vendor's database such that trustee 1204 is able to locate and access the data.

After receipt of the request, each server validates the third party's request by accessing relevant transaction history stored in a public blockchain. The use of the blockchain for recording transaction history ensures that the transaction history is valid and unaltered. For simplicity, the public blockchain will be described as being the same repository as repository 1206. However, in practice two or more repositories may be used to effect the decryption. The transaction history includes actions performed by the third party, for example payment of a specified amount to the consumer.

At step 1204′ of method 1600, the transaction history is cross referenced to predefined conditions 1208 stored in repository 1206. In the case where the predefined conditions are satisfied, such as the condition that a specified amount is paid to the consumer and/or vendor, trustee 1204 performs step 1306′: actioning the data package. In this example, the request was to action the digital object by decrypting it and hence each server 1210 partially decrypts the consumer's data using the fragment of the private key stored on that server. The partial decryption algorithm PD, with input (P, xᵢ, yᵢ) and encrypted data package (c₁, c₂), outputs:

PD((P,xᵢ,yᵢ),(c₁,c₂))=(xᵢ,c₁^{yi}(mod P),c₂)=(xᵢ,sᵢ,c₂)

After each server 1210 has performed the partial decryption of the data package, step 1308′ is performed wherein the partially decrypted data package is supplied to the third party. Step 1308′ includes sub-step 1602 in which each server encrypts the partially decrypted data package with a public key belonging to the third party.

At step 1604, the third party receives the partially decrypted data packages and decrypts the consumer data. Step 1604 includes receiving the partially actioned data packages as sub-step 1606, decrypting the partially actioned data packages as sub-step 1608 and constructing the decrypted consumer data as sub-step 1610.

As mentioned, at sub-step 1606 the third party receives the partially decrypted data packages from the servers 1210 of automated trustee 104. However, the third party cannot use the partially decrypted packages until at least the threshold number of partially decrypted packages is received. Therefore, the third party must accumulate at least the threshold number of partially decrypted packages before proceeding.

When the threshold number of partially decrypted data packages has been received, the third party performs sub-step 1608. As mentioned above, each of the partially decrypted packages has been encrypted using the public key of the third party. The third party then uses the corresponding private key to decrypt each of the packages.

At sub-step 1610 the third party reconstructs the decrypted consumer data from the threshold number of partially decrypted data packages. The method for reconstructing the data package is as described above.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method performed by a plurality of servers to each provide a share of a secret to an owner of the secret, the share generated from the secret by a cryptographic share generation method, wherein the plurality of servers each store a different share of the secret and an associated a unique identifier indicative of the owner, the unique identifier having a corresponding verifier, the method comprising each of the plurality of servers:
receiving a request from a user to provide the share stored by the server, wherein the request comprises a request identifier and a request verifier;
the server identifying the share stored by the server by comparing the request identifier with the unique identifier associated with the stored share;
the server comparing the request verifier to the verifier corresponding to the unique identifier associated with the stored share; and
if the request verifier suitably compares to the verifier corresponding to the unique identifier, authenticating the user as the owner by providing the share to the user.

2. The method of claim 1 wherein the corresponding verifier is specific to the server that stores the share.

3. The method of claim 2 wherein the corresponding verifier is generated by a deterministic process based on a public key of the server.

4. The method of claim 2 wherein the corresponding verifier is generated by a deterministic process based on an internet protocol (IP) address of the server.

5. The method of any one of claims 2 to 4 wherein the corresponding verifier comprises a share of a public key, wherein the share of the public key is generated from a public key using a cryptographic secret sharing method.

6. The method of claim 5 wherein the public key is generated from a second alphanumeric sequence provided by the user.

7. The method of any one of claims 1 to 5 wherein the corresponding verifier is based on biometric information of the user.

8. The method according to any one of the preceding claims wherein the share stored by the server is encrypted using a server public key of the server.

9. The method of any one of the preceding claims wherein the unique identifier is generated by a deterministic cryptographic hash function of a first alphanumeric sequence provided by the user.

10. The method according to any one of the preceding claims wherein each share is recorded in one or more trustless repositories.

11. The method of claim 10 wherein the trustless repository is a distributed ledger.

12. The method of any one of the preceding claims wherein the method comprises randomly selecting one or more of the plurality of servers from a pool of potential servers.

13. The method of any one of the preceding claims wherein a number of servers in the plurality of servers is greater than a threshold number.

14. The method of any one of the preceding claims further comprising the steps of:
receiving a subsequent request comprising the same request identifier; and
after a delay period, repeating the comparing steps.

15. The method of claim 14 comprising repeating claim 14 and each time increasing the delay.

16. A server for providing a share of a secret to an owner of the secret, the share generated from the secret by a cryptographic share generation method, the server comprising:
a processing unit having at least one processor configured to:
receive a request from a user to provide the share, wherein the request comprises a request identifier and a request verifier;
access one or more repositories configured to store the share of the secret and an associated a unique identifier indicative of the owner of the secret, the unique identifier having a corresponding verifier;
identify the share stored by the server by comparing the request identifier with the unique identifier associated with the share;
compare the request verifier to the verifier corresponding to the unique identifier associated with the share; and
if the request verifier suitably compares to the verifier corresponding to the unique identifier, authenticate the user as the owner by providing the share to the user.

17. A system for providing a plurality of shares of a secret to an owner of the secret, the shares generated from the secret by a cryptographic share generation method, the system comprising:
one or more repositories configured to store the shares of the secret in association with a unique identifier indicative of the owner, the unique identifier having one or more corresponding verifiers; and
a plurality of servers each configured to:
receive a request from a user to provide the share, wherein the request comprises a request identifier and a request verifier;
identify the share stored in the one or more repositories by comparing the request identifier with the unique identifier associated with the stored share;
compare the request verifier to the verifier corresponding to the unique identifier associated with the stored share; and
if the request verifier suitably compares to the verifier corresponding to the unique identifier, authenticate the user as the owner by providing the share to the user.

18. Software having instructions that when executed cause a processor to perform:
receive a request from a user to provide a share of a secret stored by the server, wherein the request comprises a request identifier and a request verifier;
access a repository storing the share of the secret, the share of the secret generated from a secret by a cryptographic share generation method,
identify the share stored in the repository by comparing the request identifier with a unique identifier associated with the stored share;
compare the request verifier to a verifier corresponding to the unique identifier associated with the stored share; and
if the request verifier suitably compares to the verifier corresponding to the unique identifier, provide the share to the user;
the software may be non-transitory computer readable medium configured to store the instructions.

19. A method performed by an owner of a secret to retrieve the secret, the method comprising:
sending a request to each of a plurality of servers, wherein each of the plurality of servers is configured to store a different share of the secret, wherein each different share of the secret was generated from the secret by a cryptographic share generation method, the request comprising a request identifier and a request verifier;
receiving a threshold number of different shares from a threshold number of servers of the plurality of servers; and
reconstructing the secret from the threshold number of different shares.

20. A device for retrieving a secret, the device comprising a processor configured to:
send a request to each of a plurality of servers, wherein each of the plurality of servers is configured to store a different share of the secret, wherein each different share of the secret was generated from the secret by a cryptographic share generation method, the request comprising a request identifier and a request verifier;
receive a threshold number of different shares from a threshold number of servers of the plurality of servers; and
reconstruct the secret from the threshold number of different shares.

21. Software having instructions that when executed cause a processor to perform:
send a request to each of a plurality of servers, wherein each of the plurality of servers is configured to store a different share of the secret, wherein each different share of the secret was generated from the secret by a cryptographic share generation method, the request comprising a request identifier and a request verifier;
receive a threshold number of different shares from a threshold number of servers of the plurality of servers; and
reconstruct the secret from the threshold number of different shares;
the software may be non-transitory computer readable medium configured to store the instructions.

22. A method performed by a plurality of servers to each provide a share of a secret to an owner of the secret, the share of the secret generated from the secret by a cryptographic share generation method, wherein the plurality of servers each store a different share of the secret in association with a unique identifier indicative of the owner, the unique identifier having a corresponding verifier, the method comprising each of the plurality of servers:
receiving a request from a user to provide the share stored by the server, wherein the request comprises a request identifier and a request verifier;
the server identifying the share stored by the server by comparing the request identifier with the unique identifier associated with the stored share;
the server combining the request verifier with the stored share and the verifier corresponding to the unique identifier associated with the stored share to define a combined share; and
providing the combined share to the user.

23. A method performed by a plurality of servers to each provide to an end user a partially actioned digital object, wherein the plurality of servers each store a different share of a cryptographic key, the method comprising each of the plurality of servers:
receiving a request to action the digital object using the cryptographic key;
determining whether one or more predefined conditions are satisfied;
where the one or more predefined conditions are satisfied, partially actioning the digital object using the share of the cryptographic key to generate a partially actioned digital object; and
providing to an end user the partially actioned digital object.

24. The method of claim 23 wherein each server stores the share of the cryptographic key in a distributed ledger.

25. The method of claim 23 or claim 24 wherein the predefined conditions are stored in a distributed ledger.

26. The method of any one of claims 23 to 25 further comprising the end user combining the partially actioned digital objects.

27. The method of any one of claims 23 to 26 wherein partially actioning the digital object comprises partially digitally signing the digital object with the share of the cryptographic key.

28. The method of any one of claims 23 to 26 wherein before providing to the end user the partially actioned digital object, each server partially encrypting the partially actioned digital object using a public key of the end user.

29. The method of any one of claims 23 to 26 wherein partially actioning the digital object comprises partially decrypting the digital object.

30. The method of any one of claims 23 to 26 wherein partially actioning the digital object comprises partially certifying the digital object through a generation of a certificate.

31. The method of any one of claims 23 to 30 wherein the method comprises selecting the plurality of servers from a pool of potential servers.

32. The method of any one of claims 23 to 31 wherein the method comprises randomly selecting one or more of the plurality of servers.

33. The method of any one of claims 23 to 33 wherein the number of servers is greater than a threshold number.

34. A system for automatically actioning a digital object with a cryptographic key, the system including:
one or more repositories for storing one or more predefined conditions and shares of the cryptographic key; and
a plurality of servers each configured to:
receive a request for the digital object to be actioned using the cryptographic key;
access a share of the cryptographic key;
determine whether one or more predefined conditions are satisfied;
where the one or more predefined conditions are satisfied, partially action the digital object using the share of the cryptographic key to generate a partially actioned digital object; and
provide to an end user the partially actioned digital object.

35. A server for partially actioning a digital object with a share of a cryptographic key, the server comprising a processor configured to:
receive a request for the digital object to be actioned using the cryptographic key;
access a share of the cryptographic key;
determine whether one or more predefined conditions are satisfied;
where the one or more predefined conditions are satisfied, partially action the digital object using the share of the cryptographic key to generate a partially actioned digital object; and
provide to an end user the partially actioned digital object.

36. A non-transitory computer readable medium configured to store instructions that when executed cause a processor to perform the method of any one of claims 23 to 33:

37. A method performed by an end user to action a digital object with a cryptographic key of an owner, the method including:
sending a request to each of a plurality of servers, wherein each of the plurality of servers is configured to store a different share of the cryptographic key and to partially action the digital object using the stored share of the cryptographic key and provide a partially actioned digital object to the end user, the request comprising proof of predefined conditions being satisfied;
receiving a threshold number of different partially actioned digital objects from a threshold number of servers of the plurality of servers;
reconstructing an actioned digital object from the threshold number of partially actioned digital objects.

38. A device for obtaining an actioned digital object, the device comprising a processor configured to:
send a request to each of a plurality of servers, wherein each of the plurality of servers is configured to store a different share of the cryptographic key and to partially action the digital object using the stored share of the cryptographic key and provide a partially actioned digital object to the end user, the request comprising proof of predefined conditions being satisfied;
receive a threshold number of different partially actioned digital objects from a threshold number of servers of the plurality of servers;
reconstruct the actioned digital object from the threshold number of partially actioned digital objects.

39. A non-transitory computer readable medium configured to store instructions that when executed cause a processor to perform the method of claim 37.
